(19) United States
(12) Patent Application Publication
(10) Pub. No.: US 2025/0369067 A1
(43) Pub. Date: Dec. 4, 2025

(54) METHOD FOR COOLING A STRIP OF STEEL

(71) Applicant: The Gillette Company LLC, Boston, MA (US)

(72) Inventors: Joaquin Elorduy LANDA, Manaus (BR); Zulema Torres LÓPEZ, León (MX)

(21) Appl. No.: 18/678,504

(22) Filed: May 30, 2024

(51) Int. Cl. C21D 9/573; C21D 11/00

(52) U.S. Cl. CPC C21D 9/573; C21D 11/005

(57) ABSTRACT

A method of cooling a strip of steel is provided. The method includes a step of feeding an elongated strip of steel within an elongated slot formed between an upper cooling block and a lower cooling block. The method also includes a step of determining a characteristic of the elongated strip of metal emerging from the elongated slot. Upon determining an undesired characteristic of the elongated strip of metal, the method includes a step of adjusting a position of the upper cooling block relative to the lower cooling block to offset the undesired characteristic. A calibration method is also provided for calibrating a system used to perform the method of cooling the strip of steel.

### FIELD OF THE INVENTION

The present disclosure relates generally to a method for forming razor blades and more specifically to a method for cooling a strip of steel used to form razor blades.

### BACKGROUND OF THE INVENTION

Conventional methods are known that are used for processing a strip of steel to form one or more blade segments that are used in razor cartridges. FIG. 1 depicts a conventional method 10 for processing a strip of metal to form one or more blade segments. The method 10 includes a first perforation step 12, where one or more perforations are formed in the strip of metal. The perforated strip of metal can then be wound on a roll before the next step. The method 10 then includes a second furnacing step 14 where the strip of metal is heated to an elevated temperature (e.g. 1500° C.). A cooling step 16 is then performed which quenches the strip temperature down to below an oxidation temperature (e.g. 300° C.). After the cooling step, the strip of metal may be positioned on a roll. The strip of metal is subsequently sharpened in step 18 before the strip is cut in step 20 into one or more blade segments. After this cutting step 20, the conventional method 10 includes a step 22 involving other operations (e.g. washing, coating, etc.).

FIG. 2 depicts a conventional system 50 that is used to perform the cooling step 16 of the conventional method 10. The conventional system 50 features an upper cooling block 52 and a lower cooling block 54. Water is passed through each of the upper cooling block 52 and the lower cooling block 54, to maintain the blocks 52, 54 at a reduced temperature in order to cool the strip of metal 51 after the furnacing step 14. The strip of metal 51 with the elevated temperature is passed between the upper and lower cooling blocks 52, 54 to perform the cooling step 16.

The discussion of shortcomings and needs existing in the field prior to the present disclosure is in no way an admission that such shortcomings and needs were recognized by those skilled in the art prior to the present disclosure.

### SUMMARY OF THE INVENTION

Although conventional systems and conventional methods are provided for processing the elongated strip of steel to form one or more blade segments, the inventors of the present invention recognized that these conventional systems and methods have noticeable drawbacks. For example, although the conventional method utilizes the system 50 provided with the upper and lower cooling blocks 52, 54 to facilitate the cooling step 16, the inventors determined that such conventional methods have limited adjustability in terms of their ability to vary a spacing between the upper and lower cooling blocks 52, 54 through which the strip of metal passes. The inventors determined that this is a key drawback of such conventional methods, since the spacing between the upper and lower cooling blocks 52, 54 needs to be adjusted in order to ensure effective cooling of the strip of metal. The inventors noted that although some conventional methods feature an adjustment means for varying the spacing between the upper and lower blocks 52, 54, such adjustment means are coarse and imprecise and thus require an operator with extensive knowledge and experience to know what specific type of adjustment is needed. Additionally, since these conventional methods feature imprecise and coarse adjustment of the spacing, the inventors realized that the upper and lower blocks 52, 54 routinely come into repeated abrasive contact, which accelerates the wear and tear of the blocks.

The inventors determined that it would be beneficial to provide a method for performing the cooling step that features precise and fine-tune adjustment of the spacing between the upper and lower cooling blocks. The inventors recognized that this would advantageously allow an operator to perform precise adjustment of the spacing (e.g. after such precise adjustment is communicated to the operator) without requiring that the operator have extensive personal knowledge or experience in adjusting the spacing. The inventors also recognized that the precise and fine-tune adjustment of the improved method would advantageously extend the life and/or reduce the maintenance window of the system, as it would drastically reduce wear and tear due to abrasive contact between the upper and lower cooling blocks.

Various embodiments solve the above-mentioned problems and provide methods and systems useful for cooling an elongated strip of metal that passes through a spacing between the upper cooling block and lower cooling block. The method herein provides one or more adjustable pins that are used to achieve precise and fine-tune adjustment of the spacing between the upper cooling block and the lower cooling block. This precise and fine-tune adjustment of the spacing by the method advantageously results in the elongated strip of metal having one or more desired characteristics (e.g. minimal sweep, minimal distortion, etc.) after the cooling step.

In a first set of embodiments, a steel strip quenching method is provided. The method includes a step of feeding a first elongated strip of steel between a front upper cooling block and a lower cooling block. The method further includes a step of adjusting a position of the front upper cooling block relative to the lower cooling block.

In a second set of embodiments, a method of cooling a strip of steel is provided. The method includes a step of feeding an elongated strip of steel within an elongated slot formed between an upper cooling block and a lower cooling block. The method also includes a step of determining a characteristic of the elongated strip of metal emerging from the elongated slot. Upon determining an undesired characteristic of the elongated strip of metal, the method includes a step of adjusting a position of the upper cooling block relative to the lower cooling block to offset the undesired characteristic.

In a third set of embodiments, a method of calibrating a system for cooling a strip of steel is provided. The method includes a step of providing a height indicator with a probe configured to measure a height of an upper cooling block mounted on a lower cooling block with a plurality of adjustable pins. The method also includes a step of retracting, into the upper cooling block, each of the adjustable pins such that the upper cooling block is in contact and not parallel to the lower cooling block along a width thereof. The method also includes a step of extending, out of the upper cooling block, one of the adjustable pins into contact with the lower cooling block until the upper cooling block is parallel with the lower cooling block along the width thereof. The extending step includes measuring, with the height indicator, a same first height of the upper cooling block along a width thereof. The method also includes a step of extending, out of the upper cooling block, the remaining adjustable pins into contact with the lower cooling block until an increase in the height is detected with the height indicator from the same first height to a same second height. The extending step includes measuring, with the height indicator, the same second height of the upper cooling block along a width thereof. The method also includes a step of extending, out of the upper cooling block, each adjustable pin into contact with the lower cooling block until an increase in the height is detected with the height indicator from the same second height to a same third height and such that a gap is provided between a quench plate of the upper cooling block and a quench plate of the lower cooling block with a desired value.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures, which illustrate examples according to various embodiments.

FIG. 1 is a flow chart depicting one or more steps of a conventional method for processing a strip of steel used to form one or more blade segments;

FIG. 2 is a block diagram depicting a conventional system that is used during the cooling step of the conventional method of FIG. 1;

FIG. 3A is a front perspective view of an example of a system for cooling a strip of steel, according to various embodiments;

FIG. 3B is a cross-sectional view of an elongated slot defined between an upper and lower quench plate of the system of FIG. 3A, according to various embodiments;

FIG. 3C is a cross-sectional view of an elongated strip of metal positioned in the elongated slot of FIG. 3B, according to various embodiments;

FIG. 3D is a cross-sectional view of the system of FIG. 3A taken along the line 3D-3D, according to various embodiments;

FIG. 3E is a cross-sectional view of the system of FIG. 3A taken along the line 3E-3E, according to various embodiments;

FIG. 3F is a rear perspective view of an example of a system for cooling a strip of steel, according to various embodiments;

FIG. 4 is an exploded view of an example of the system of FIG. 3A, according to various embodiments;

FIGS. 5A through 5C are various views of an example of the front upper cooling block of the system of FIG. 3A, according to various embodiments;

FIGS. 6A through 6C are various views of an example of a micrometer mounted to the front upper cooling block of the system of FIG. 3A, according to various embodiments;

FIG. 7 is a front perspective view of an example of the lower cooling block of the system of FIG. 3A, according to various embodiments;

FIG. 8 is a top view of an example of the lower cooling block of the system of FIG. 3A, according to various embodiments;

FIG. 9A is a cross-sectional view of the elongated strip of metal positioned within the elongated slot of the system of FIG. 3A with a first clearance between the elongated strip and the quench plate of the front upper cooling block, according to various embodiments;

FIG. 9B is a cross-sectional view of the elongated strip of metal positioned within the elongated slot of the system of FIG. 3A with a reduced second clearance between the elongated strip and the quench plate of the front upper cooling block, according to various embodiments;

FIG. 9C is a top view of the elongated strip of metal passing through the system of FIG. 3A with zero sweep, according to various embodiments;

FIG. 10A is a cross-sectional view of the elongated strip of metal positioned within the elongated slot of the system of FIG. 3A with a reduced clearance to the upper quench plate at a sharpened edge of the elongated strip, according to various embodiments;

FIG. 10B is a top view of the elongated strip of metal passing through the system of FIG. 3A with negative sweep, according to various embodiments;

FIG. 11A is a cross-sectional view of the elongated strip of metal positioned within the elongated slot of the system of FIG. 3A with a reduced clearance to the upper quench plate at a control edge of the elongated strip, according to various embodiments;

FIG. 11B is a top view of the elongated strip of metal passing through the system of FIG. 3A with positive sweep, according to various embodiments;

FIG. 12A is a block diagram of an example of an electronic height indicator used to measure a height of the front upper block mounted on the lower cooling block of the system of FIG. 3A, according to various embodiments;

FIG. 12B is a block diagram of an example of the front upper block in contact and not parallel with the lower cooling block along a width thereof with the adjustable pins retracted into the front upper block, according to various embodiments;

FIG. 12C is a block diagram of an example of the front upper block in contact and parallel with the lower cooling block along a width thereof with one of the adjustable pins extended and in contact with the lower cooling block, according to various embodiments;

FIG. 12D is a block diagram that illustrates an example of a top view of the front upper block of FIG. 12C and a plurality of measurement points at which the electronic height indicator measured a same height, according to various embodiments;

FIG. 12E is a block diagram of an example of the front upper block in contact and parallel with the lower cooling block along a width thereof with each of the adjustable pins extended and in contact with the lower cooling block, according to various embodiments;

FIG. 12F is a block diagram that illustrates an example of a top view of the front upper block of FIG. 12E and a plurality of measurement points at which the electronic height indicator measured a same height, according to various embodiments;

FIG. 12G is a block diagram of an example of a first height or gap formed between the upper and lower quench plates based on an extension of each of the adjustable pins from the arrangement of FIG. 12E, according to various embodiments;

FIG. 12H is a block diagram that illustrates an example of a top view of the front upper block of FIG. 12G that indicates each of the micrometers that were adjusted to achieve the first height or gap of FIG. 12G, according to various embodiments;

FIG. 13A is a flowchart that depicts an example of one or more steps of a method for cooling an elongated strip of metal to achieve desired characteristics of the elongated strip of metal, according to various embodiments;

FIG. 13B is a flowchart that depicts an example of one or more steps of a method for cooling an elongated strip with the system of FIG. 3A to achieve desired sweep of the elongated strip of metal, according to various embodiments; and

FIG. 13C is a flowchart that depicts an example of one or more steps of a method for initially calibrating the adjustable pins of the system of FIG. 3A, according to various embodiments.

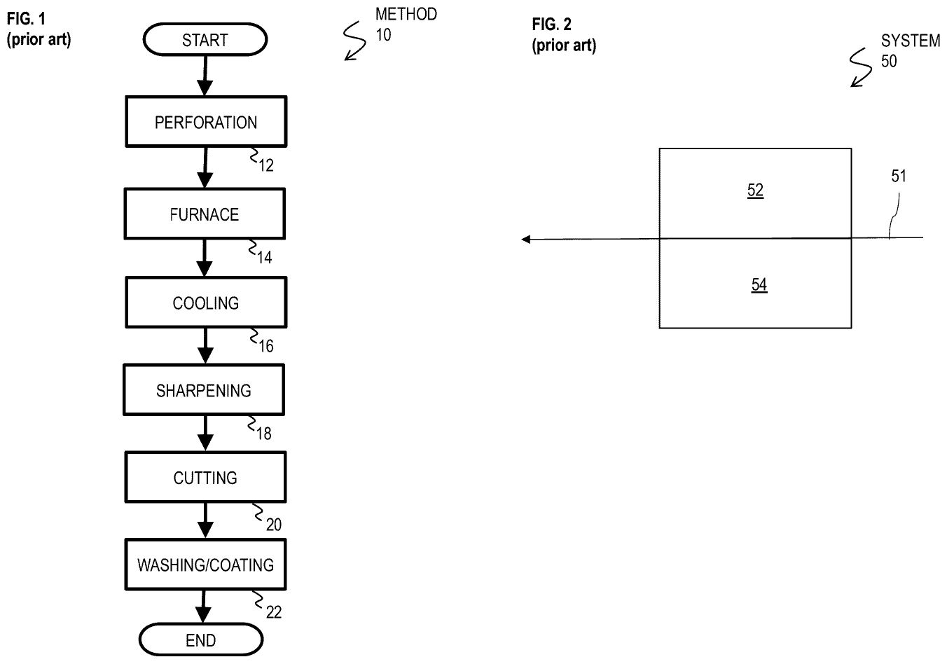

It should be understood that the various embodiments are not limited to the examples illustrated in the figures.

### DETAILED DESCRIPTION OF INVENTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Sweep” generally refers to deviation of an elongated strip of metal within a plane defined by the elongated strip of metal.

“Distortion” generally refers to deviation of an elongated strip of metal within a plane that is perpendicular to a plane defined by the elongated strip of metal.

### System Overview

A system that is used for cooling an elongated strip of metal (e.g. steel) during the cooling step of the method for forming one or more razor blade segments is now discussed. This system 100 receives the elongated strip of metal after the furnacing step of the method, where the strip of metal has an elevated temperature (e.g. about 1500° C.). The system 100 is configured to control the cooling characteristics of the strip of metal so to quench its temperature down from the elevated furnace temperature to a temperature below oxidation (e.g. about 300° C.). Additionally, the system 100 is configured to constrict movement of the strip of metal and adjust its cooling characteristics as it passes through the system, in order to ensure that the strip of metal emerges from the system with one or more desired characteristics. In some embodiment, the strip of metal undergoes an iron phase change of Austinite to Martensite as it passes through the system.

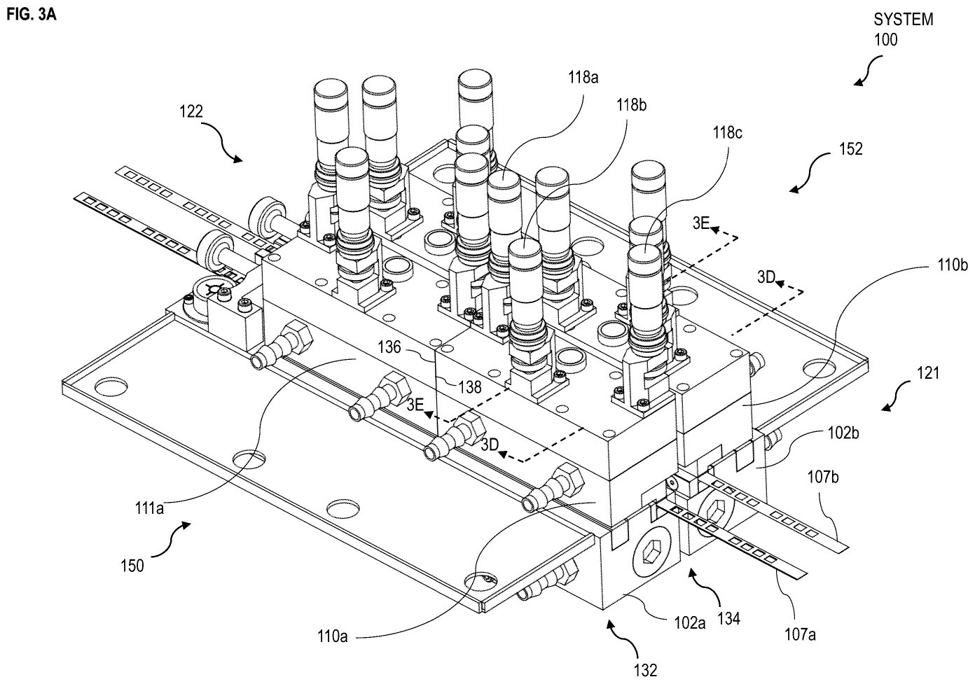

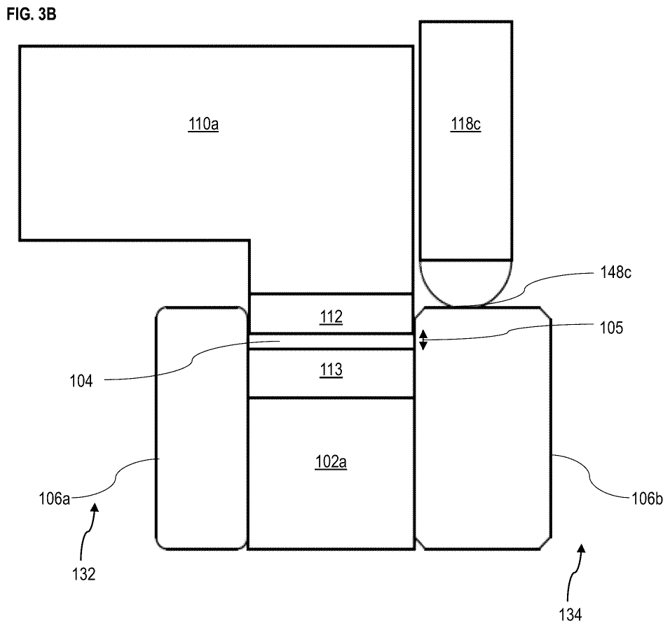

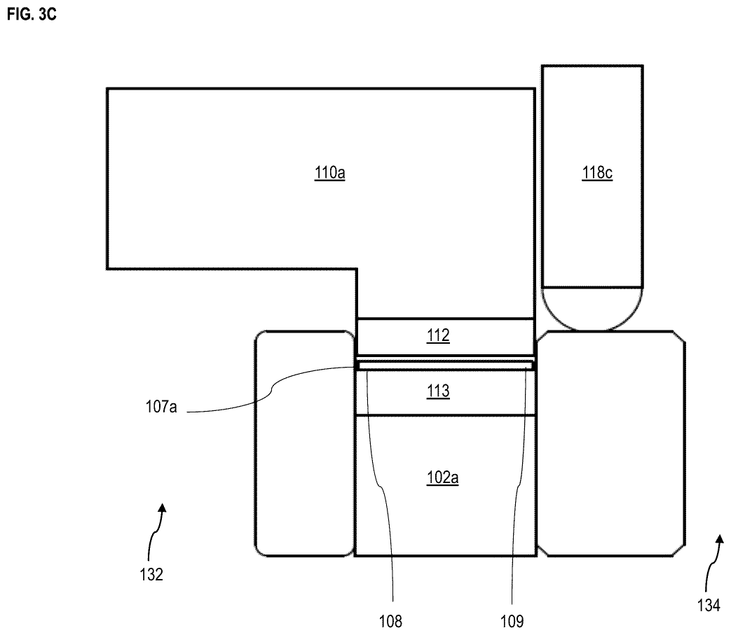

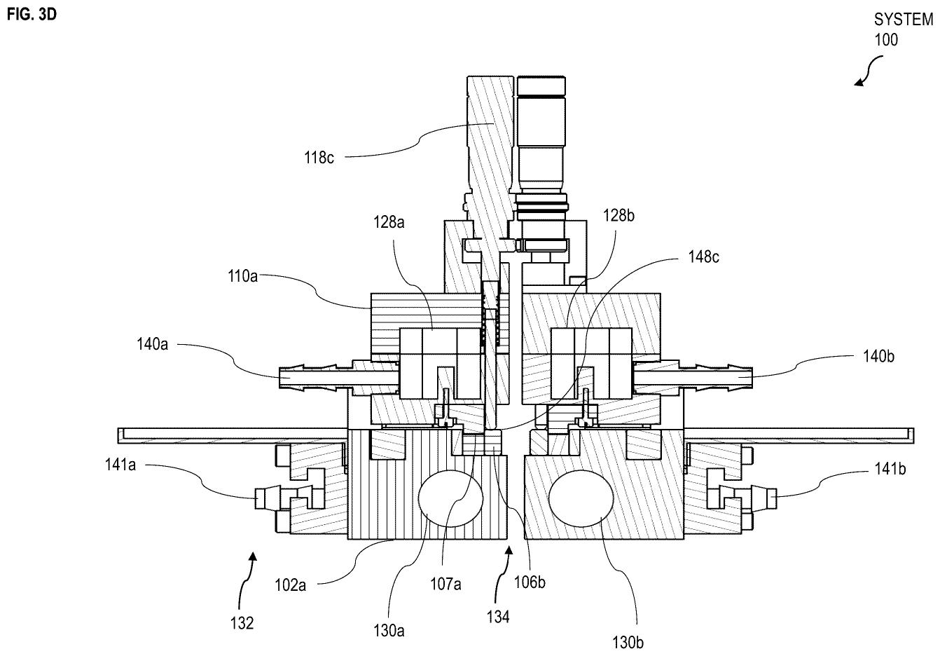

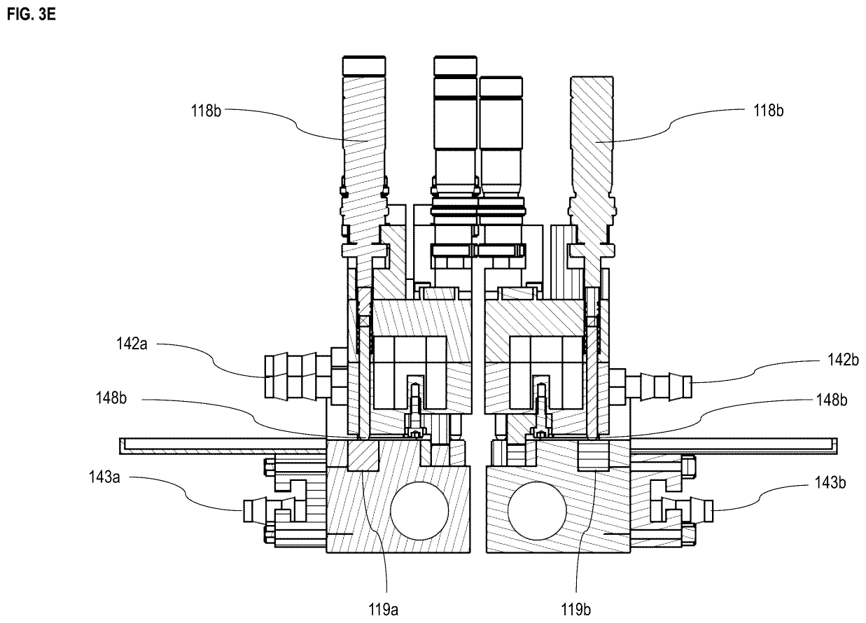

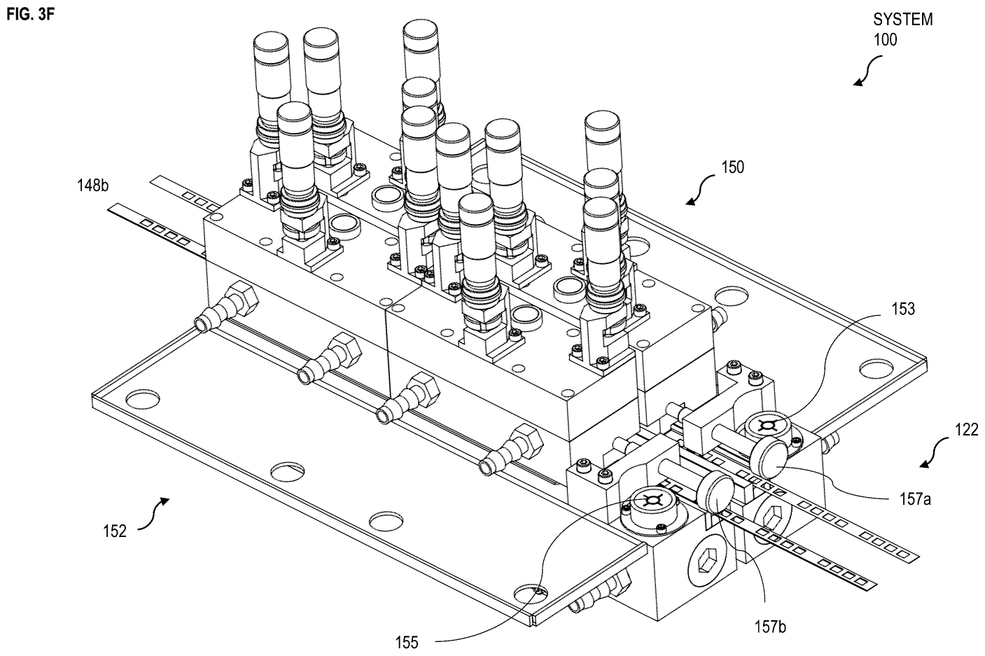

FIG. 3A is a front perspective view of an example of a system 100 for cooling a strip of steel 107, according to various embodiments. The system 100 is a steel quenching system that includes a lower cooling block 102a and a front upper cooling block 110a that is mounted to the lower cooling block 102a at a front end 121 of the system 100. The strip of steel 107a passes through a gap formed between the front upper cooling block 110a and the lower cooling block 102a. The system 100 disclosed herein is provided to adjust the position of the front upper cooling block 110a relative to the lower cooling block 102a and thus adjust the gap formed therebetween in order to achieve ideal cooling characteristics of the strip of steel 107a passing therethrough. As a result of this adjustment of the relative position of the front upper cooling block 110a and lower cooling block 102a and thus adjustment of the gap, the strip of steel 107a emerges at a rear end 122 of the system 100 with one or more desired characteristics.

In addition to passing between a gap formed between the front upper cooling block 110a and the lower cooling block 102a adjacent the front end 121 of the system 100, the system 100 of FIG. 3A further depicts that the strip of steel 107a passes through a gap formed between a rear upper cooling block 111a and the lower cooling block 102a adjacent a rear end 122 of the system 100. As shown in FIG. 3A, a front face 136 of the rear upper cooling block 111a contacts a rear face 138 of the front upper cooling block 110a. Thus, in some embodiments system 100 adjusts the position of both the front and rear upper cooling blocks 110a, 111a relative to the lower cooling block 102a, in order to achieve desired characteristics of the strip of steel 107a emerging at the rear end 122 of the system 100. In these embodiments, the positions of the rear and front upper cooling blocks 110a, 111a are adjusted so that the collective cooling effect on the strip of steel 107a passing through the system 100 results in the desired characteristics of the strip of steel 107a. However, in other embodiments, the strip of steel 107a only passes through the gap formed between the front upper cooling block 110a and the lower cooling block 102a and thus in these embodiments the rear upper cooling block 111a is omitted.

In addition to a first strip of steel 107a passing through a gap formed between the front upper cooling block 110a and the lower cooling block 102a on a left side 150 of the system 100, the system 100 of FIG. 3A further depicts a second strip of steel 107b passing through a gap formed between a front upper cooling block 110b and a lower cooling block 102b on a right side 152 of the system 100. Thus, in some embodiments the system 100 adjusts the position of both the front upper cooling blocks 110a, 110b and the rear upper cooling blocks 111a, 111b relative to the lower cooling blocks 102a, 102b on the left and right sides 150, 152 of the system 100, to achieve desired characteristics of two strips of steel 107a, 107b that emerge at the rear end 122 of the system 100. However, in other embodiments, only a single strip of steel 107a passes through the gap formed between the front upper cooling block 110a and the lower cooling block 102a of the system 100 and thus in these embodiments the front upper cooling block 110b and lower cooling block 102b on the right side 152 of the system 100 are omitted.

For purposes of this description, the adjustment of the position of the front upper cooling block 110a relative to the lower cooling block 102a on the left side 150 of the system 100 is discussed. However, the adjustment of the front upper cooling block 110b relative to the lower cooling block 102b would be conducted in a similar manner. Additionally, the adjustment of the rear upper cooling blocks 111a, 111b relative to the lower cooling blocks 102a, 102b would also be conducted in a similar manner, with the exception that the scale of adjustment of the rear upper cooling blocks 111a, 111b would be tailored so that the combined adjustment of the front and rear upper cooling blocks achieves desired cooling characteristics and thus desired characteristics of the strip of steel as it passes through the gaps formed between the front and rear upper cooling blocks 110a, 111a and the lower cooling block 102a. a

The adjustment of the position of the front upper cooling block 110a relative to the lower cooling block 102a is now discussed. In some embodiments, one or more actuators are mounted to the front upper cooling block 110a and are configured to adjust the position of the front upper cooling block 110a relative to the lower cooling block 102a. In some embodiments, the one or more actuators include a plurality of micrometers 118a, 118b, 118c mounted to the front upper cooling block 110a. Each micrometer 118a, 118b, 118c is operatively connected to an adjustable pin (not shown). Upon rotation of each micrometer 118 in a first direction (e.g. clockwise), the respective adjustable pin for that micrometer presses against the lower cooling block 102a and consequently increases the spacing between the front upper cooling block 110a and the lower cooling block 102a. Upon rotation of each micrometer 118 in a second direction (e.g. counter clockwise), the respective adjustable pin for that micrometer retracts into the upper cooling block 110a and away from the lower cooling block 102a, thereby decreasing the spacing between the front upper cooling block 110a and the lower cooling block 102a.

As shown in FIG. 3A, in some embodiments, a pair of micrometers 118a, 118c are positioned along an inboard side 134 of the front upper cooling block 110a, where the inboard side 134 is defined as the side of the front upper cooling block 110a adjacent to the front upper cooling block 110b. Additionally, in these embodiments a micrometer 118b is positioned along an outboard side 132 of the front upper cooling block 110a, where the outboard side 132 is opposite to the inboard side 134. Thus, in these example embodiments, two micrometers are provided to adjust the spacing between the front upper cooling block 110a and the lower cooling block 102a along the inboard side 134 thereof whereas one micrometer is provided to adjust a spacing between the front upper cooling block 102a and the lower cooling block 102 along the outboard side 132 thereof. As shown in FIG. 3A, these micrometers 118a, 118b, 118c form a triangular pattern on the front upper cooling block 110a. Although FIG. 3A depicts that the actuators include a plurality of micrometers and a particular arrangement of three micrometers, this is merely one example embodiment and the system includes other embodiments, such as actuators other than micrometers and a number of such actuators that is less than or more than three actuators.

The spacing between the front upper cooling plate 110a and the lower cooling plate 102a that is adjusted by the system 100 is now discussed. As shown in FIG. 3B, an elongated slot 104 is defined between an upper quench plate 112 of the front upper cooling plate 110a and a lower quench plate 113 of the lower cooling plate 102a. The upper quench plate 112 is positioned above the lower quench plate 113. The elongated slot 104 is also defined between a pair of sidewalls 106a, 106b of the lower cooling block 102a. The elongated slot 104 has a height or clearance 105 as shown in FIG. 3B. By adjusting the position of the front upper cooling block 110a relative to the lower cooling block 102a, the height or clearance 105 of the slot 104 is adjusted over some or all of the width of the slot 104. For example, as shown in FIG. 3B, a tip 148c of the adjustable pin of the micrometer 118c presses on the sidewall 106b in order to increase or decrease (depending on the rotation direction of the micrometer 118c) the height or clearance 105 on the inward side 134 of the slot 104.

FIG. 3C is a cross-sectional view of the elongated strip of metal 107a positioned in the elongated slot 104 of FIG. 3B, according to various embodiments. A control edge 109 of the elongated strip 107 is positioned on the inward side 134 of the elongated slot 104 and a sharpened edge 108 of the elongated strip 107 is positioned on the outward side 132 of the elongated slot 104. The sharpened edge 108 is that edge of the elongated strip 107 that will be sharpened in a subsequent sharpening step of the method for forming one or more razor blade segments. The rate of cooling of the elongated strip 107 depends on the spacing between the elongated strip 107 and the upper quench plate 112 within the slot 104. Thus, in some embodiments where the front upper cooling plate 110a is adjusted so to reduce the spacing between the strip 107 and quench plate 112, this increases the rate of cooling of the elongated strip 107. In other embodiments, where the front upper cooling plate 110a is adjusted to increase the spacing between the strip 107 and quench plate 112, this reduces the rate of cooling of the elongated strip 107. This is due to a coolant (not shown) circulating through the front upper cooling plate 110a to reduce its temperature. Thus, increased proximity of the upper quench plate 112 to the elongated strip 107 has an enhanced cooling effect on the elongated strip 107. In some embodiments discussed herein, the cooling effect can be varied across a width of the elongated strip 107 by varying the spacing between the elongated strip 107 and the upper quench plate 112 over the width of the elongated strip 107. This variation of the spacing and hence variation of the cooling effect across the width of the elongated strip 107 is performed to reverse an uneven cooling across the width of the elongated strip 107 that causes one or more undesired characteristics (e.g. sweep) in the elongated strip 107.

In some embodiments where the rear upper cooling block 111a is provided, the rear upper cooling block 111a also has an upper quench plate 112 that is similar to the upper quench plate 112 of the front upper cooling block 110a and is positioned above a respective lower quench plate 113 of the lower cooling block 102a to form the elongated slot 104. The system 100 is further configured to adjust the position of the upper quench plate 112 relative to the lower quench plate 113 so to achieve desired cooling effects on the strip of steel 107a passing through the gap 104 between the upper quench plate 112 of the rear upper cooling block 111a and the lower quench plate 113 of the lower cooling plate 102a. In an example embodiment, the adjustment of the upper quench plate 112 of the rear upper cooling block 111a is performed so that a combined adjustment of the upper quench plates 112 of both the rear and front upper cooling blocks 110a, 111a achieve a desired cooling effect and thus desired characteristics of the strip of steel 107a emerging at the rear end 122 of the system 100.

In some embodiments where the front upper cooling block 110b is provided, the front upper cooling block 110b also has an upper quench plate 112 that is similar to the upper quench plate 112 of the front upper cooling block 110a and is positioned above a respective lower quench plate 113 of the lower cooling block 102b to form the elongated slot 104. The system 100 is further configured to adjust the position of the upper quench plate 112 of the front upper cooling block 110b in a similar manner as the upper quench plate 112 of the front upper cooling block 110a in order to achieve desired cooling effects on the strip of steel 107b passing through the gap 104 between the upper quench plate 112 and the lower quench plate 113.

Some cross-sectional views of the system 100 of FIG. 3A are now discussed, which are used to further describe the various components of the system 100. FIG. 3D is a cross-sectional view of the system 100 of FIG. 3A taken along the line 3D-3D, according to various embodiments. FIG. 3E is a cross-sectional view of the system 100 of FIG. 3A taken along the line 3E-3E, according to various embodiments. As shown in FIG. 3D, in one embodiment, the system 100 includes an actuator that is the micrometer 118c that is mounted to the front upper cooling block 110a adjacent the inboard side 134. The micrometer 118c is configured to adjust the position of the quench plate 112 of the front upper cooling block 110a relative to the quench plate 113 of the lower cooling block 102a along the inboard side 134. In one example embodiment, the micrometer 118c includes an adjustable pin whose tip 148c engages the lower cooling block 102a. As shown in FIG. 3B, in one embodiment the tip 148c of the adjustable pin of the micrometer 118c engages one of the sidewalls 106b of the lower cooling block 102a that forms the elongated slot 104. In one example embodiment, upon rotation of the micrometer 118c in a first direction (e.g. clockwise), the tip 148c presses against the sidewall 106b and thus causes the upper cooling block 110a to rise relative to the lower cooling block 102a and consequently for the elongated slot 104 to increase in height or clearance, at least on the inboard side 134 of the elongated slot 104. In another example embodiment, upon rotation of the micrometer 118c in a second direction (e.g. counter clockwise), the tip 148c retracts from the sidewall 106b and thus causes the upper cooling block 110a to lower relative to the lower cooling block 102a and consequently for the elongated slot 104 to reduce in height or clearance, at least on the inboard side 134 of the elongated slot 104.

Although not depicted in FIG. 3D, the system 100 also features a second actuator that is the micrometer 118a (FIG. 3A) which is similarly aligned with the upper cooling block 102a as the micrometer 118c. As with the micrometer 118c, the micrometer 118a also features an adjustable pin whose tip engages the sidewall 106b of the lower cooling block 102a but does this adjacent the rear face 138 of the upper cooling block 110a. Thus, as with the micrometer 118c, rotation of the micrometer 118a will cause the tip of the adjustable pin either engage or retract from the sidewall 106b and thus consequently cause the upper cooling block 110a to respective rise or lower towards the lower cooling block 102a, at least on the inboard side 134 of the elongated slot 104. However, unlike the micrometer 118c that is positioned adjacent the front end 121 of the upper cooling block 110a and thus varies the height or clearance of the elongated gap 104 adjacent the front end 121, the micrometer 118a is positioned adjacent the rear face 138 of the upper cooling block 110a and thus causes the height or clearance of the elongated slot 104 to vary proximate to the rear face 138.

FIG. 3E depicts a third actuator that is the micrometer 118b (FIG. 3A) which is positioned adjacent the outboard side 132 of the upper cooling block 102a. The upper cooling block 102b features a similar micrometer 118b that is also positioned adjacent the outboard side 132 of the upper cooling block 102b. The micrometer 118b is configured to adjust the position of the quench plate 112 of the front upper cooling block 110a relative to the quench plate 113 of the lower cooling block 102a along the outboard side 132. In one example embodiment, the micrometer 118b includes an adjustable pin whose tip 148b engages an outer block 119a of the lower cooling block 102a. As shown in FIG. 3E, the outer block 119a is positioned adjacent the outboard side 132 of the lower cooling block 102a. The lower cooling block 102b similarly features an outboard block 119b which is similarly engaged by the tip 148b of the adjustable pin of the micrometer 118b of the right upper cooling block 102b. In one example embodiment, upon rotation of the micrometer 118b in a first direction (e.g. clockwise), the tip 148b presses against the outer block 119a and thus causes the upper cooling block 110a to rise relative to the lower cooling block 102a and consequently for the elongated slot 104 to increase in height or clearance, at least on the outboard side 132 of the elongated slot 104. In another example embodiment, upon rotation of the micrometer 118b in a second direction (e.g. counter clockwise), the tip 148b retracts from the outer block 119a and thus causes the upper cooling block 110a to lower relative to the lower cooling block 102a and consequently for the elongated slot 104 to reduce in height or clearance, at least on the outboard side 132 of the elongated slot 104.

In an embodiment, each of the actuators that include the micrometers 118a, 118b, 118c are independent and thus can be independently adjusted relative to each other with fine tune precision. The inventors recognized that this advantageously permits a wide range of different fine-tuned adjustable positions of the upper cooling block relative to the lower cooling block, which can be used to counteract a wide variety of different undesired cooling characteristics that can cause one or more undesired characteristics of the elongated strip of steel emerging from the system.

Although FIGS. 3D and 3E depicts three actuators including three micrometers 118a, 118b, 118c mounted to each upper cooling block, in other embodiments less or more than three actuators can be provided so to selectively vary the height or clearance of the gap 104 at more than three locations along the upper cooling block. In still other embodiments, although micrometers are depicted as an example of the actuators, in other embodiments any actuator can be used other than micrometers provided that they are capable of facilitating fine tune and precise adjustment of the extension or retraction of the adjustable pin tip relative to the lower cooling block.

One or more cooling channels formed in the system 100 are now discussed. In some embodiments, these cooling channels are provided for a cooling medium (e.g. water) having a reduced temperature (e.g. about 33° C.) relative to temperature (e.g. about 1500° C.) of the incident strip of steel 107 from the furnacing step of the method for forming one or more razor blade segments. Thus, these cooling channels are provided to provide a flow path of this cooling medium through the upper cooling blocks and the lower cooling blocks, so to facilitate cooling of the elongated strips of steel 107a, 107b passing through the system 100. By adjusting the proximity of the upper cooling block 110a to the elongated strip of steel 107a, this adjusts the rate of cooling of the elongated strip of steel 107a.

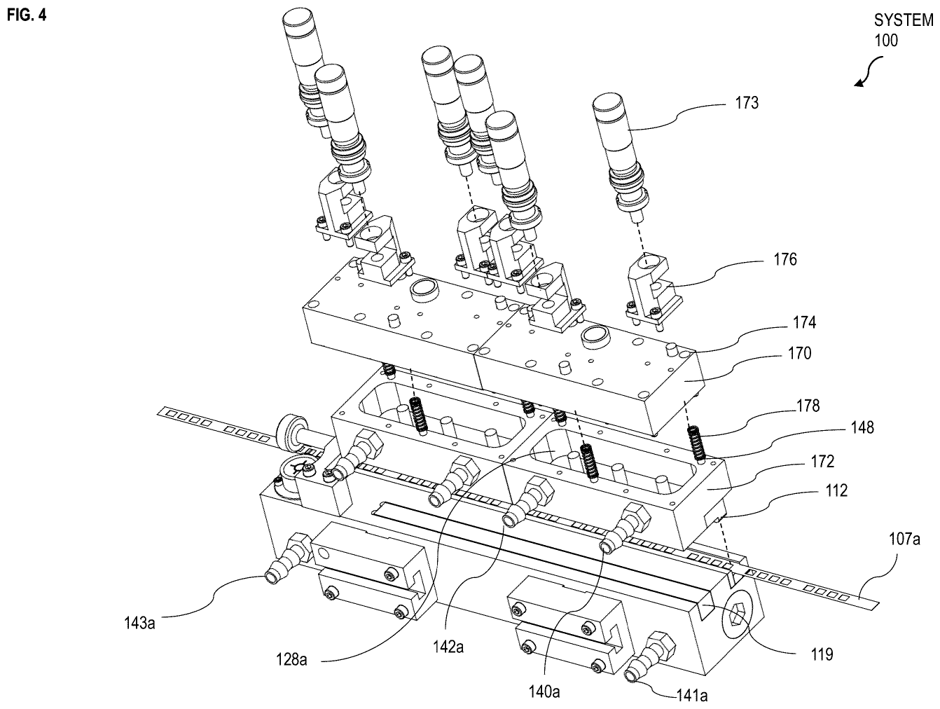

As shown in FIGS. 3D, 3E and 4, in one embodiment the front upper cooling block 110a has a cooling channel 128a. The right upper cooling block 110b features a similar cooling channel 128b. As further depicted in FIGS. 3D and 4, the system 100 features an inlet valve 140a for passing a cooling medium (e.g. water) into the cooling channel 128a. As shown in FIG. 3D, the right upper cooling block 110b similarly features an inlet valve 140b for passing a cooling medium (e.g. water) into the cooling channel 128b. As further depicted in FIGS. 3E and 4, the system 100 also features an outlet valve 142a for the cooling medium (e.g. water) to exit the cooling channel 128a. As shown in FIG. 3E, the right upper cooling block 110b similarly features an inlet valve 142b for the cooling medium (e.g. water) to exit the cooling channel 128b.

As further shown in FIGS. 3D, 3E and 4, in one embodiment the lower cooling block 102a also has a cooling channel 130a. The right lower cooling block 102b also has a cooling channel 130b. As with the cooling channels 128a, 128b of the upper cooling blocks 110a, 110b, the cooling channels 130a, 130b of the lower cooling blocks 102a, 102b feature an inlet valve 141a, 141b for passing a cooling medium (e.g. water) into the cooling channels 130a, 130b. Similarly, the cooling channels 130a, 130b of the lower cooling blocks 102a, 102b also feature an outlet valve 143a, 143b for the cooling medium (e.g. water) exiting the cooling channels 130a, 130b.

Different portions of the micrometer are now discussed. As shown in the exploded view of FIG. 4, in one embodiment the micrometer includes a plurality of interconnected components. A handle 173 is provided that includes measurement indicia (not shown) and which can be moved by the operator to adjust the position of the tip 148 of the adjustable pin. The handle 173 is mounted to the upper surface of the upper cooling block 110 using a mount 176. In some embodiments, the mount 176 features one or openings that are respectively aligned with one or more openings 174 in the upper surface of the upper cooling block 110. The mount 176 is secured to the upper surface of the upper cooling block 110 by passing fasteners through the aligned opening of the mount 176 and the openings 174 of the upper cooling block 110. The micrometer also includes the adjustable pin with a threaded axis 178 that features threads (e.g. external threads) configured to engage complimentary threads (e.g. internal threads) of an opening in the upper cooling block 110. The tip 148 of the adjustable pin is also depicted in FIG. 4. The example embodiment of the micrometer depicted in FIG. 4 is merely one example arrangement of a micrometer that is used to adjust the tip of the adjustable pin. Thus, the system is not limited to this particular structural arrangement of the micrometer and includes other embodiments which feature other structural arrangements of micrometers or other actuators capable of fine tune adjustment of the position of the tip of the adjustable pin.

As further shown in FIG. 4, in some embodiments each upper cooling block 110 features a first block 170 and a second block 172 which are secured together. In one example embodiment, one or more fasteners pass through respective openings of the blocks 170, 172 which are aligned to secure the blocks 170, 172 together. In one example embodiment, the second block 172 of the upper cooling block 110 defines the cooling channel 128 and the first block 170 seals the cooling channel 128 when securely mounted to the second block 172.

FIG. 3F is a rear perspective view of an example of a system 100 for cooling a strip of steel, according to various embodiments. As shown in FIG. 3F, in some embodiments the rear end 122 of the system 100 includes level indicators 153, 155 respectively positioned on an upper surface of the lower cooling blocks 102a, 102b. These level indicators include a movable component (e.g. bubble) that indicates the cooling blocks 102a, 102b are level when in a certain position (e.g. bubble positioned within a center of a circle). This advantageously confirms that the cooling blocks 102a, 102b (and hence the upper cooling blocks 110, 111 mounted thereon) are level with respect to each other and relative to the ground surface. Thus, when the elongated strip of steel 107 is passed through the system 100, this ensures that the elongated slot 104 formed between the upper and lower cooling blocks is level with respect to the elongated strip of steel 107 (e.g. which is also confirmed to be level using another level indicator). Although FIG. 3F depicts the rear end 122 of the system as having the level indicators 153, 155, in other embodiments the front end 120 can also feature similar level indicators, to also confirm that the upper and lower cooling blocks are level to each other at the front end 120 of the system 100 and/or with respect to the elongated strip of steel 107 incident on the front end 120 of the system 100.

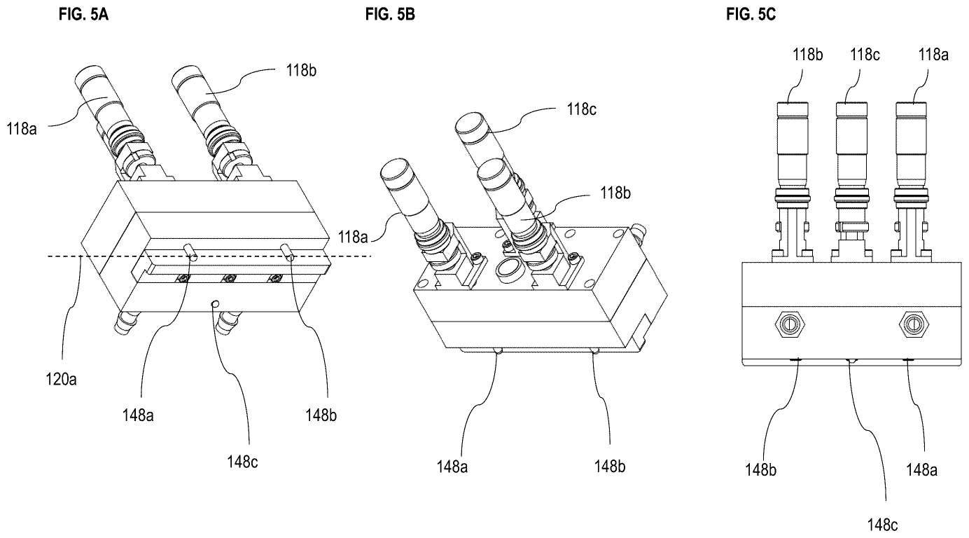

FIGS. 5A through 5C are various views of an example of the front upper cooling block 110a of the system 100 of FIG. 3A, according to various embodiments. FIGS. 5A through 5C depict the tips 148a, 148b of the adjustable pins of the micrometers 118a, 118b that are configured to engage the outer block 119a of the lower cooling block 102a. As shown in FIG. 5A, in one embodiment, the adjustable pins of the micrometers 118a, 118b (including the tips 148a, 148b) are aligned along an axis 120a that is parallel to the elongated slot 104. In an example embodiment, when the upper cooling block 110a is mounted to the lower cooling block 102a the axis 120a is aligned with the outer block 119a of the lower cooling block 102a. FIG. 5A also depicts the tip 148c of the adjustable pin of the micrometer 118c that is configured to engage the sidewall 106b adjacent the inward side 134 of the upper cooling block 102a.

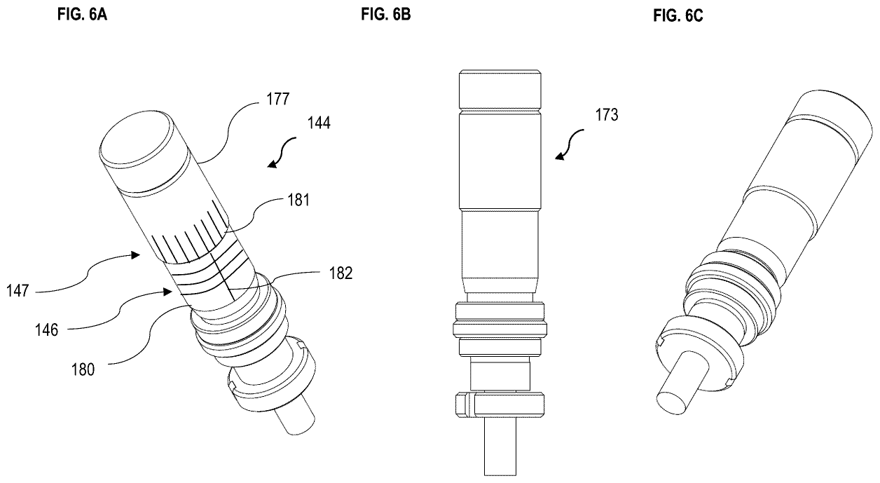

One embodiment of the handle 173 of the micrometer 118 is now discussed. FIGS. 6A through 6C are various views of an example of a handle 173 of the micrometer 118 mounted to the front upper cooling block 110a of the system 100 of FIG. 3A, according to various embodiments. As shown in FIG. 6A, the micrometer handle 173 features a rotatable portion 177 that can be rotated relative to a fixed portion 180. Major divisions 146 are provided along the fixed portion 180 and minor divisions 147 are provided on the rotatable portion 177. Based on rotation of the rotatable portion 177 relative to the fixed portion 180, an edge 181 of the rotatable portion 177 moves along the fixed portion 180. The major division 146 aligned with the edge 184 corresponds to a currently measured major division. Additionally, based on rotation of the rotatable portion 177 relative to the fixed portion 180, the minor divisions 147 move relative to a vertical line 182 along the fixed portion 180. The minor division 147 aligned with the vertical line 182 corresponds to a currently measured minor division 147. Accordingly, the tip of the adjustable pin of each micrometer can be either extended or retracted based on a currently measured position of the micrometer 118 indicated by the currently measured major division 146 and currently measured minor division 147. In one example embodiment, the minor division 147 is between about 5 μm to about 15 μm and thus the tip of each adjustable pin is movable in increments of about 5 μm to about 15 μm. In one example embodiment, clockwise rotation of the rotatable portion 177 relative to the fixed portion 180 causes extension of the adjustable pin tip by the indicated increment whereas counterclockwise rotation of the rotatable portion 177 relative to the fixed portion 180 causes retraction of the adjustable pin tip by the indicated increment.

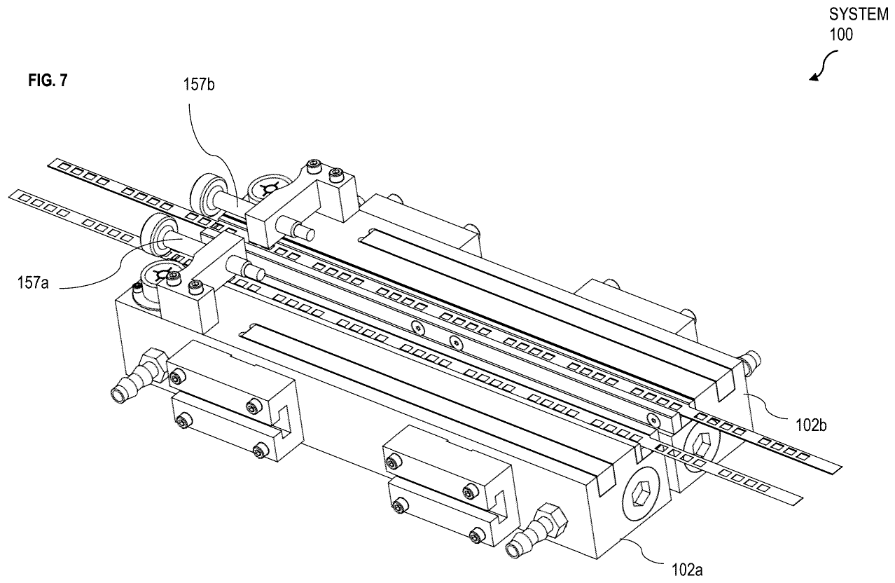

A rail and slot of the system 100 that is used to secure the upper cooling block 110 to the lower cooling block 102 is now discussed. FIG. 7 is a front perspective view of an example of the lower cooling blocks 102a, 102b of the system 100 of FIG. 3A, according to various embodiments. In some embodiments, as shown in FIG. 7 the bolts 157a, 157b adjacent the rear end 122 of the system 100 constrain the upper cooling blocks 110, 111 in a first direction (e.g. parallel to the direction of movement of the elongated strip 107 from the front end 120 to the rear end 122 of the system 100). Additionally, as depicted in FIG. 3B, the upper cooling blocks 110, 111 are constrained in a second direction orthogonal to the first direction, where the two sidewalls 106a, 106b constrain the upper quench plate 122 of the upper cooling blocks 110, 111 in this second direction. In one example embodiment, the second direction is parallel to a direction along the width of the upper cooling blocks 110, 111 (e.g. a direction from the outboard side 132 to the inboard side 134).

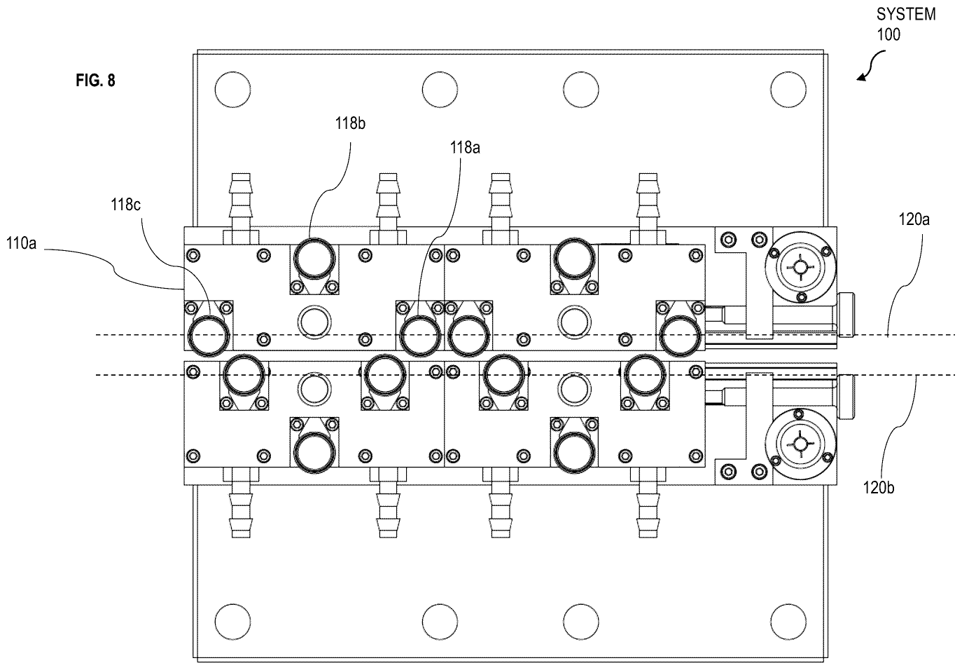

FIG. 8 is a top view of an example of the system 100 of FIG. 3A, according to various embodiments. The front upper cooling block 110a is depicted in FIG. 8. Additionally, FIG. 8 shows a top view of the micrometers 118a, 118b, 118c that are similarly arranged on each upper cooling block of the system 100 (e.g. in a triangular arrangement). This top view of the micrometers 118a, 118b, 118c on each upper cooling block can be used to reference the relative rotation direction of each micrometer 118a, 118b, 118c in various scenarios in order to achieve desired characteristics of the elongated strip of steel 107a, 107b emerging from the system 100.

### System Adjustment

The adjustment of one or more components of the system 100 will now be discussed, depending on various situations, in order to ensure desired characteristics of the elongated strip of steel 107a, 107b emerging from the system 100.

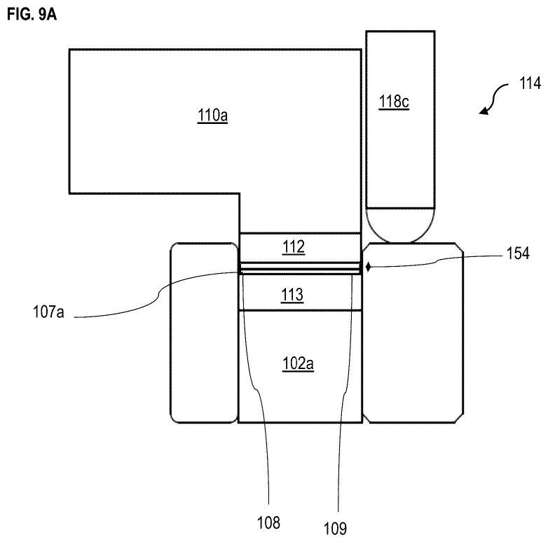

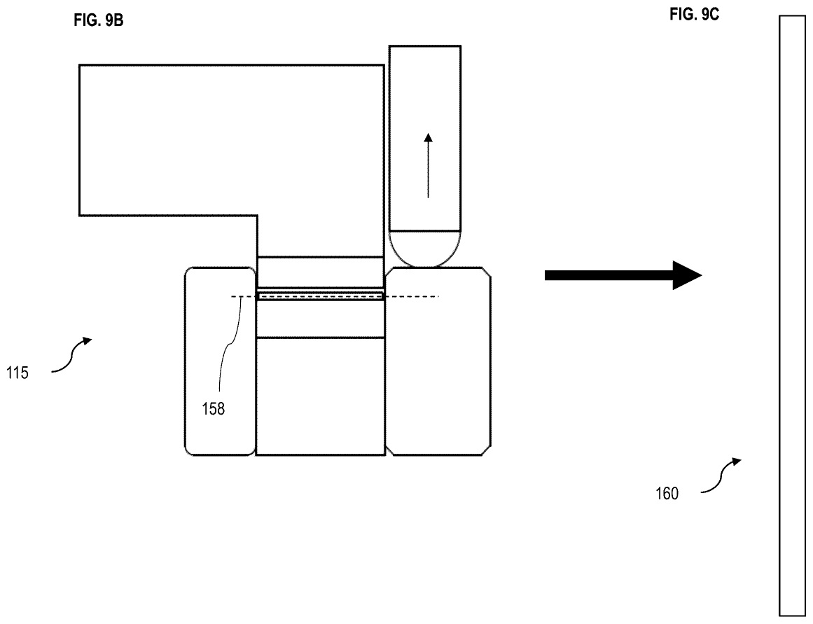

A first adjustment of the system 100 to be discussed herein involves parallel adjustment of the upper cooling block 110a relative to the lower cooling block 102a, so that the upper quench plate 112 is either uniformly raised or uniformly lowered relative to the lower quench plate 113 along a width of the elongated slot 104 (FIG. 3C). This parallel adjustment of the upper quench plate 112 results in either a uniform increase or uniform decrease in the height or clearance between the elongated strip 107a and the upper quench plate 112 (FIG. 3C). FIG. 9A is a cross-sectional view of the elongated strip of metal 107a positioned within the elongated slot 104 of the system 100 of FIG. 3A with a first clearance 154 between the elongated strip 107 and the quench plate 112 of the front upper cooling block 110a, according to various embodiments. FIG. 9B is a cross-sectional view of the elongated strip of metal 107a positioned within the elongated slot 104 of the system 100 of FIG. 3A with a reduced second clearance between the elongated strip 107a and the quench plate 112 of the front upper cooling block 110a, according to various embodiments. Thus, in moving the quench plate 112 from the first position in FIG. 9A to the second position in FIG. 9B, the quench plate 112 is moved downward (towards the lower quench plate 113) by a uniform amount across the width of the elongated slot 104. In an example embodiment, this parallel movement of the quench plate 112 downward towards the quench plate 113 is achieved by adjusting each of the micrometers 118a, 118b, 118c by a same extent. In an example embodiment, each micrometer 118a, 118b, 118c is rotated in a counterclockwise decision by a same extent (e.g. same number of minor divisions 147) which in turn causes each tip 148a, 148b, 148c of the adjustable pins of the micrometers 118a, 118b, 118c to retract from the lower cooling block 102a by the same extent. This includes the tips 148a, 148c of the micrometers 118a, 118c retracting from the inboard side 134 of the lower cooling block 102a and the tip 148b of the micrometer 118b retracting from the outboard sided 132 of the lower cooling block 102a by a same extent. Consequently, the quench plate 112 of the upper cooling block 110a lowers towards the quench plate 113 of the lower cooling block 102a on both the outboard side 132 and inboard side 134 by the same extent.

Although FIGS. 9A and 9B depict a parallel adjustment of the upper quench plate 112 towards the lower quench plate 113, in other embodiments a parallel adjustment of the upper quench plate 112 away from the lower quench plate 113 can be performed by rotating the micrometers 118a, 118b, 118c to a same extent in the opposite direction (e.g. clockwise) to the direction of rotation between FIGS. 9A and 9B. In this embodiment, the quench plate 112 is moved upward (away the lower quench plate 113) by a uniform amount across the width of the elongated slot 104. In an example embodiment, this parallel movement of the quench plate 112 upwards away from the quench plate 113 is achieved by adjusting each of the micrometers 118a, 118b, 118c by a same extent. In an example embodiment, each micrometer 118a, 118b, 118c is rotated in a clockwise decision by a same extent (e.g. same number of minor divisions 147) which in turn causes each tip 148a, 148b, 148c of the adjustable pins of the micrometers 118a, 118b, 118c to extend and press against the lower cooling block 102a by the same extent. This includes the tip 148b of the micrometer 118b pressing against the outer block 119a (outboard side 132) of the lower cooling block 102a and the tips 148a, 148c of the micrometers 118a, 118c pressing against the sidewall 106b (inboard side 134) of the lower cooling block 102a by a same extent. Consequently, the quench plate 112 of the upper cooling block 110a raises away from the quench plate 113 of the lower cooling block 102a on both the outboard side 132 and inboard side 134 by the same extent.

When the upper quench plate 112 is oriented in a parallel arrangement relative to the lower quench plate 113 across the width of the elongated slot 104, as depicted in FIG. 9B, one or more desired characteristics are expected of the elongated strip of steel 107 emerging from the system 100. For example, as shown in FIG. 9C in one embodiment, when the upper quench plate 112 has a parallel arrangement relative to the lower quench plate 113 across the width of the elongated slot 104, the elongated strip of steel 107 emerging from the system 100 should have zero sweep 160 (e.g. where there is no deviation of the elongated strip of steel 107 within a plane 158 defined by the elongated strip).

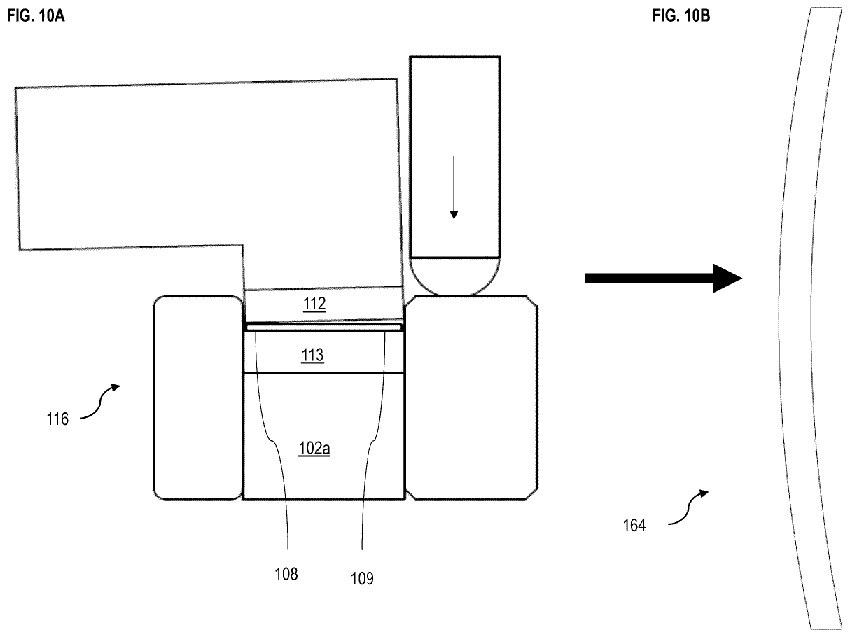

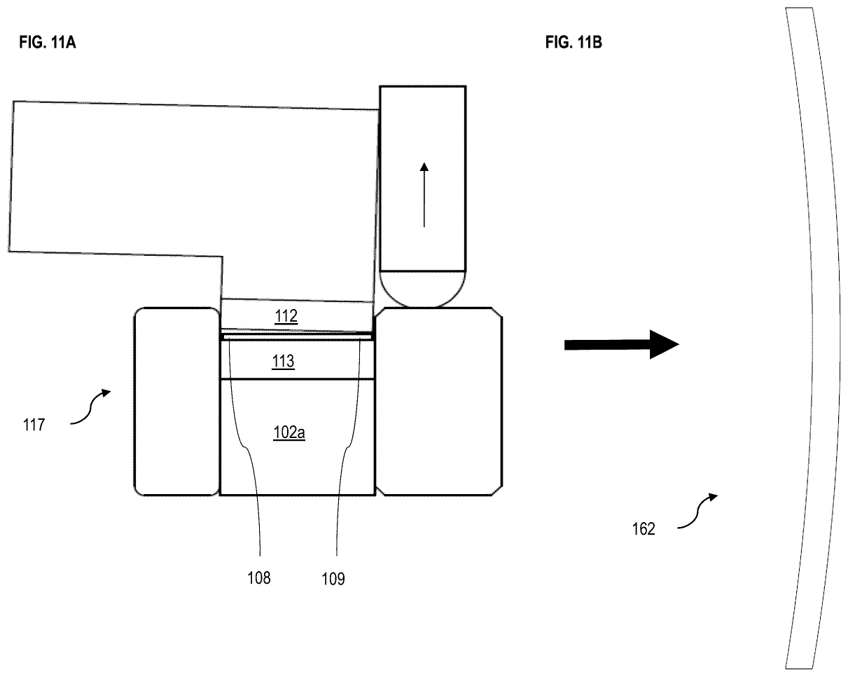

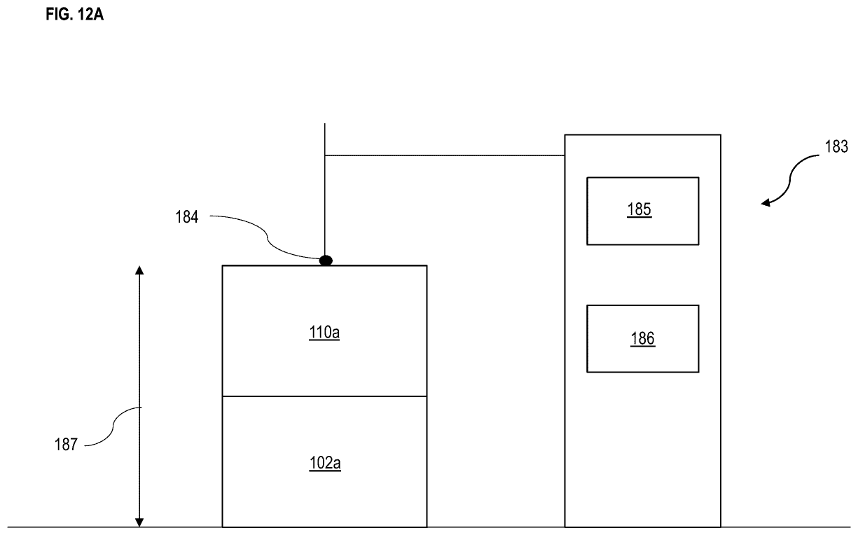

However, the inventors of the present invention recognized that although zero sweep 160 of the elongated strip of steel 107 emerging from the system 100 is ideal, the strip of steel 107 emerging from the system can have one or more undesired characteristics (e.g. undesired sweep) that is addressed by the system 100 disclosed herein. In some embodiments, the undesired characteristic is positive sweep 162 (FIG. 11B) which depicts the elongated strip 107 deviating within the plane 158 towards the control edge 109 (when viewing the elongated strip 107 from above with the control edge 109 on the right side thereof). In order to combat and reverse this undesired positive sweep 162, the inventors of the present invention recognized that a negative sweep 164 (FIG. 10B) could be induced which would then result in the desired characteristic of net zero sweep 160 (FIG. 9C). Thus, in this embodiment, the micrometers 118a, 118b, 118c are adjusted so that the upper quench plate 112 is moved relative to the lower quench plate 113 so that the height or clearance between the elongated strip of steel 107a and the upper quench plate 112 is greater on the control edge 109 (inboard side 134) of the elongated strip 107 than on the sharpened edge 108 (outboard side 132) of the elongated strip of steel 107a, as depicted in FIG. 10A. This results in increasing the cooling rate of the sharpened edge 108 relative to the control edge 109 of the elongated strip of steel 107. This adjustment of the upper quench plate 112 is achieved by adjusting the micrometer 118b on the outboard side 132 of the upper cooling block 110a so to lower the upper quench plate 112 towards the lower quench plate 113 on the outboard side 132 and/or by adjusting the micrometers 118a, 118c on the inboard side 134 of the upper cooling block 110a so to raise the upper quench plate 112 from the lower quench plate 113 on the inboard side 134 of the upper cooling block 110a.

In some embodiments, the undesired characteristic is negative sweep 164 (FIG. 10B) which depicts the elongated strip 107 deviating within the plane 158 towards the sharpened edge 108 (when viewing the elongated strip 107 from above with the control edge 109 on the right side thereof). In order to combat and reverse this undesired negative sweep 164, the inventors of the present invention recognized that a positive sweep 162 (FIG. 11B) could be induced which would then result in the desired characteristic of net zero sweep 160 (FIG. 9C). Thus, in this embodiment, the micrometers 118a, 118b, 118c are adjusted so that the upper quench plate 112 is moved relative to the lower quench plate 113 so that the height or clearance between the elongated strip of steel 107a and the upper quench plate 112 is greater at the sharpened edge 108 (outboard side 132) of the elongated strip 107 than on the control edge 109 (inboard side 134) of the elongated strip of steel 107a, as depicted in FIG. 11A. This results in increasing the cooling rate of the control edge 109 relative to the sharpened edge 108 of the elongated strip of steel 107. This adjustment of the upper quench plate 112 is achieved by adjusting the micrometer 118b on the outboard side 132 of the upper cooling block 110a so to raise the upper quench plate 112 away from the lower quench plate 113 on the outboard side 132 and/or by adjusting the micrometers 118a, 118c on the inboard side 134 of the upper cooling block 110a so to lower the upper quench plate 112 towards the lower quench plate 113 on the inboard side 134.

### System Calibration

Prior to using the system 100, the system is calibrated. In this calibration, the height or clearance 105 of the elongated gap 104 is first adjusted to a minimum value (e.g. zero). The indicia of the micrometers 118 (e.g. major divisions 146 and minor divisions 147) are adjusted to correspond to this minimum value (e.g. zero). The height or clearance 105 of the elongated gap 104 is then increased to a desired initial value for use of the system 100 with the elongated strip of steel 107 positioned therein. Although the calibration of the system 100 is discussed with respect to the upper cooling block 110a, the calibration of the upper cooling blocks 110b, 111a, 111b are calibrated in a similar manner with the exception that the desired initial value of the height or clearance 105 may differ between the front and rear upper cooling blocks.

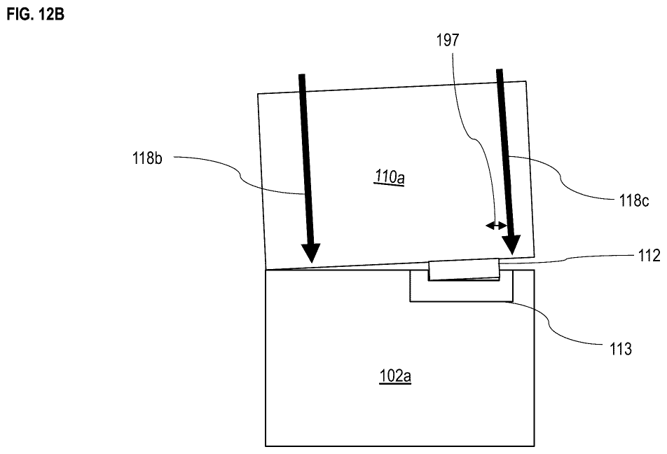

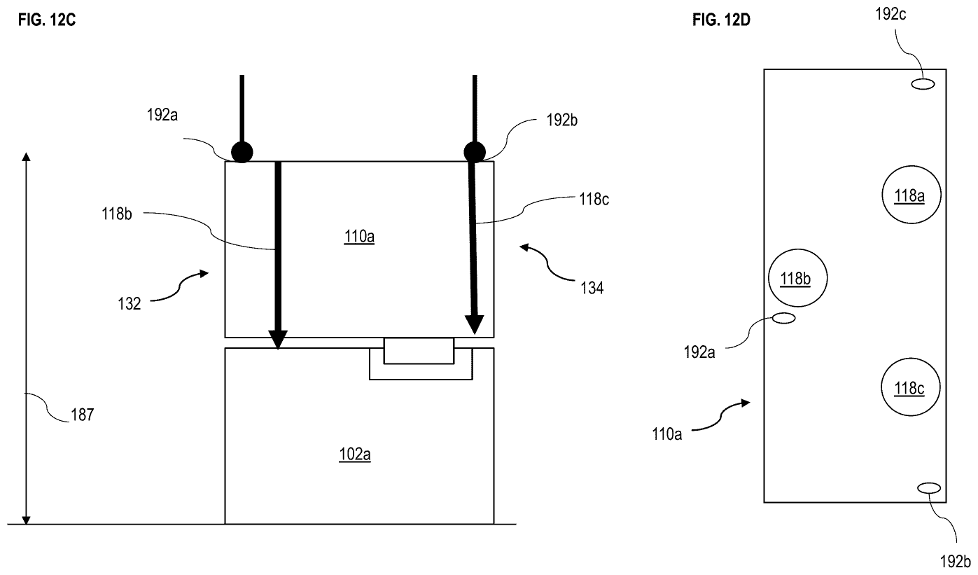

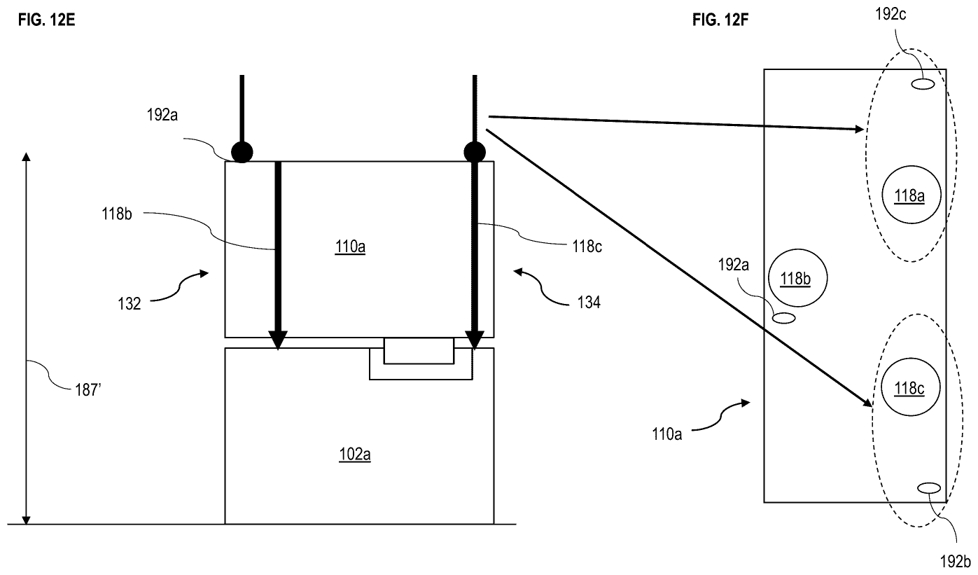

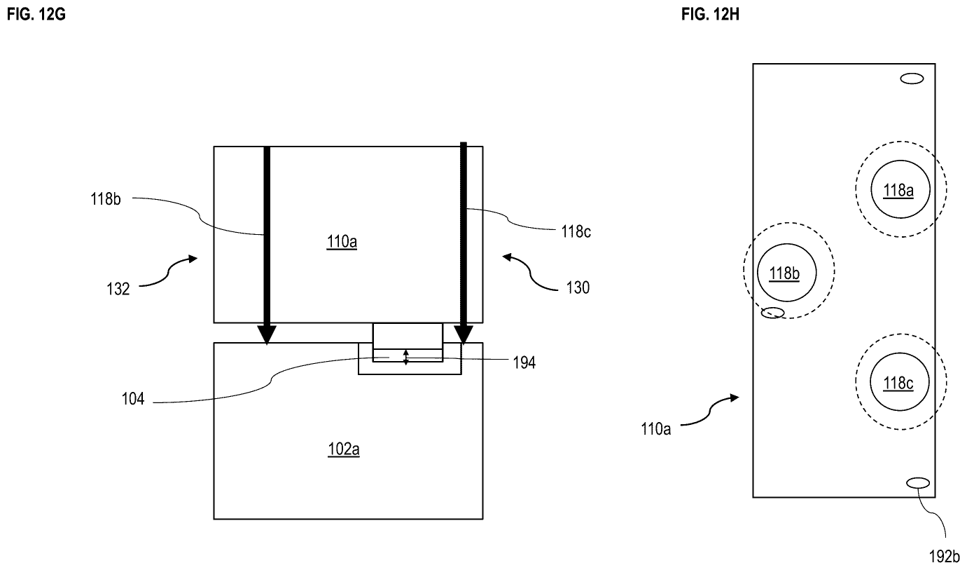

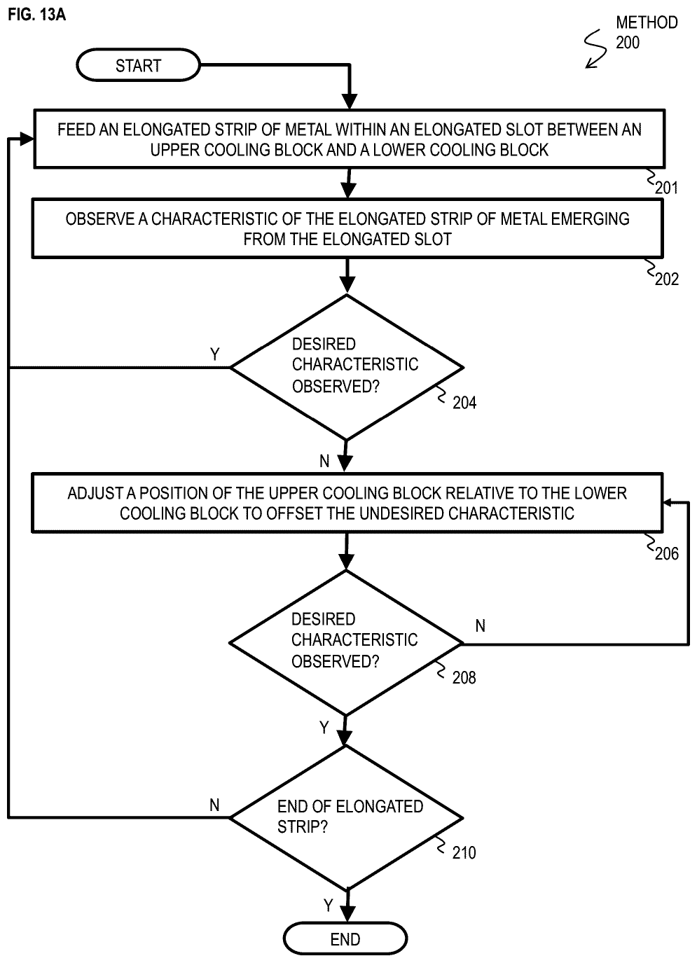

FIG. 12A is a block diagram of an example of an electronic height indicator 183 used to measure a height 187 of the front upper block 110a mounted on the lower cooling block 102a of the system 100 of FIG. 3A, according to various embodiments. The electronic height indicator 183 includes a probe 184 positioned on a surface (e.g. top surface of the upper cooling block 110a) to measure the height 187 of the surface. The electronic height indicator also includes a display 185 (e.g., to output a value of the measured height 187) and a user interface 186 configured to receive user input (e.g. to assign an initial value to the measured height 187, such as to assign a zero value to an initial measured height 187). A drive or motor (not shown) may be provided that is used to move the probe 184 up and down. Although the electronic height indicator 183 is depicted in FIG. 12A, the system herein is not limited to this particular electronic height indicator 183 to measure the height of the upper cooling block 110a and can include any device capable of measuring a height of the upper cooling block 110a including manual height measurement.

FIG. 12B is a block diagram of an example of the front upper block 110a in contact and not parallel with the lower cooling block 102a along a width thereof. The tips 148 of the adjustable pins of the micrometers 118 are retracted into the front upper cooling block 110a. In this embodiment, each micrometer 118a, 118b, 118c has been fully rotated in the clockwise position so that the tips 148 of the adjustable pins of each micrometer 118 have fully retracted out of contact with the lower cooling block 102a and into the upper cooling block 110a. The front upper cooling block 110a is not parallel with the lower cooling block 102a along the width thereof, since the outboard side 132 of the upper cooling block 110a contacts the lower cooling block 102a yet the inboard side 134 of the upper cooling block 110 does not contact the lower cooling block 102a (due to the upper quench plate 112 protruding out of the elongated slot 104). As shown in FIG. 12B, in some embodiments one or more of the pins 148 are positioned at a distance 197 from the upper quench plate 112 that is about 0.0462″±0.0001″ or 1.173±0.0025 mm (front upper cooling blocks 110a, 110b) or about 0.0468″±0.0001″ or 1.189±0.0025 mm (rear upper cooling blocks 111a, 111b).

The system 100 is then adjusted from the non-parallel arrangement between the upper cooling block 110a and lower cooling block 102a of FIG. 12B to a parallel arrangement. FIG. 12C is a block diagram of an example of the front upper cooling block 110a in contact and parallel with the lower cooling block 102a along a width thereof with one of the adjustable pins extended and in contact with the lower cooling block 102a, according to various embodiments. In order to adjust the system 100 from the non-parallel arrangement of FIG. 12B to the parallel arrangement of FIG. 12C, the micrometer 118b on the outboard side 132 of the system 100 is adjusted so that the tip 148b of the adjustable pin extends out of the upper cooling block 110a into contact with the outer block 119a of the lower cooling block 102a until the upper and lower cooling blocks 102a, 110a are parallel along the width thereof. In order to confirm that the upper and lower cooling blocks 102a, 110a are parallel along the width thereof, the probe 184 of the electronic height indicator 183 is positioned at a plurality of measurement points 192a, 192b along the width of the upper cooling block 110a. The micrometer 118b is continuously rotated so to extend the tip 148b of the adjustable pin until the measured height 187 values at the measurement points 192a, 192b are equal. FIG. 12D is a block diagram that illustrates an example of a top view of the front upper cooling block 110a of FIG. 12C and a plurality of measurement points 192a, 192b, 192c at which the electronic height indicator 183 measured a same height 187, according to various embodiments. Although the discussion of FIG. 12C indicated that the micrometer 118b is adjusted until the measured height values at the measurement points 192a, 192b are equal, the micrometer 118b can also be adjusted until the measured height values at all three measurement points 192a, 192b, 192c are equal.

As previously discussed, in FIG. 12C only the tip 148b of the adjustable pin of the micrometer 118b is in contact with the lower cooling block 102a. Thus, in order to further calibrate the system 100, each of the tips 148a, 148c of the adjustable pins of the remaining micrometers 118a, 118c are to be also brought into contact with the lower cooling block 102a. As shown in FIG. 12E, the micrometers 118a, 118c are rotated (e.g. in a clockwise direction) so to cause the tips 148a, 148c of the adjustable pins to extend out of the upper cooling block 110a and into contact with the lower cooling block 102a. The micrometers 118a, 118c are only rotated until such time as a change is detected in the height from the same height 187 of FIG. 12D to a same increased height 187′ of FIG. 12E. The inventors recognized that adjustment of the micrometers 118a, 118c until a change in the measured height is detected ensures that each of the tips 148a, 148c are in contact with the lower cooling block 102a. As with the discussion of FIG. 12C, the same increased height 187′ of FIG. 12E is determined based on measuring the same increased height 187′ with the electronic height indicator 183 at each of the measurement points 192a, 192b, 192c, as depicted in FIG. 12F. Additionally, as with the discussion of FIG. 12C, the measurement of the same increased height 187′ at each of the measurement points 192a, 192b, 192c ensures that the upper cooling block 110a is parallel to the lower cooling block 102a along the width thereof. In some embodiments, the micrometers 118 can be adjusted so that their indicia 144 indicates the minimum value of the height or clearance 105 of the adjustable slot 104 in FIG. 12E (e.g. zero).

After moving the system 100 so that the height or clearance 105 of the elongated slot 104 has a minimum value, the system 100 is then adjusted so that the height or clearance 105 has an initial desired value for use of the system 100. FIG. 12G is a block diagram of an example of a first height or gap 194 of the elongate slot 104 formed between the upper and lower quench plates 112, 113 based on an extension of each of the adjustable pins from the arrangement of FIG. 12E, according to various embodiments. In this embodiment, each of the micrometers 118a, 118b, 118c are further rotated (e.g. in a clockwise direction) by an equal amount so that the tips 148a, 148b, 148c of the adjustable pins further press against the lower cooling block 102a and increase the spacing between the upper and lower cooling blocks 102a, 110b until the desired height or clearance 194 is measured within the elongated slot 104. Since the scale or indicia 144 of the micrometer 118 was previously adjusted to zero in the arrangement of FIG. 12E, the micrometers 118a, 118b, 118c are adjusted until the scale or indicia 144 of each micrometer 118 indicates the value of the desired height or gap 194 of the elongated slot 104. This is because prior to adjusting the micrometers 118a, 118b, 118c, there was a zero height or clearance of the slot 104 (FIG. 12E) and the scale or indicia 144 of each micrometer 118 was set to zero. Thus, the indicated value on the scale or indicia 144 of each micrometer 118 after adjusting the micrometers 118a, 118b, 118c reflects the value of the gap 194 of the elongated slot 104. For the front upper cooling blocks 110a, 110b the value of the desired height or clearance 194 is about 0.0038″. For the rear upper cooling blocks 111a, 111b the value of the desired height or clearance 194 is about 0.032″.

### Method of Using the System to Achieve Desired Strip Characteristics

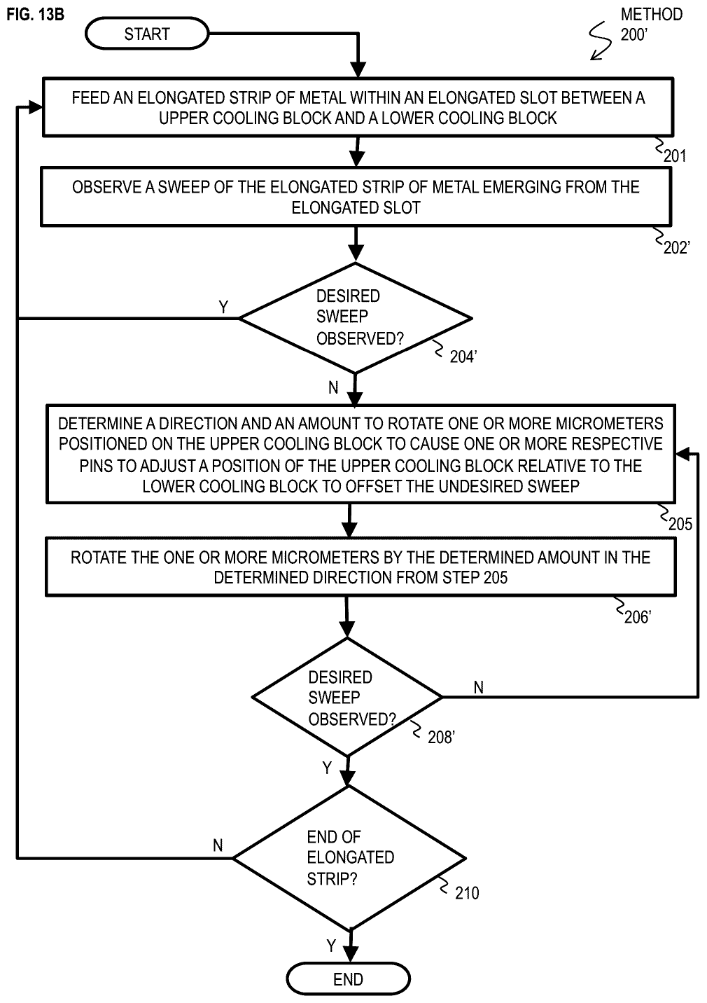

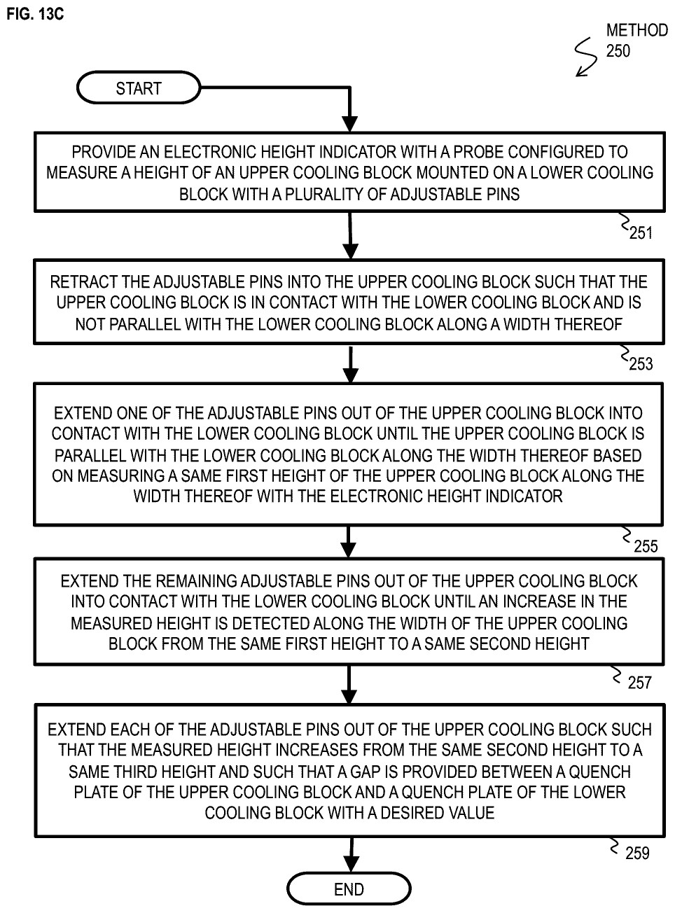

A flowchart depicting one or more steps of a method for cooling a strip of steel is now discussed. FIG. 13A is a flowchart that depicts an example of one or more steps of a method 200 for cooling an elongated strip of metal 107 to achieve desired characteristics of the elongated strip of metal, according to various embodiments. Although steps are depicted in FIG. 13A and in subsequent flowcharts in FIGS. 13B and 13C as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

The steps of the method 200 herein are discussed as being performed with one or more of the upper cooling blocks 110a, 111a of the system 100 with respect to the lower cooling block 102a. However, the steps can be performed in a similar manner with respect to one or more of the upper cooling blocks 110b, 111b of the system 100 with respect to the lower cooling block 102b.

In step 201, an elongated strip of metal is fed within an elongated slot between an upper cooling block and a lower cooling block. As shown in FIGS. 3A and 3C, in one embodiment in step 201 the elongated strip of steel 107a is fed within the elongated slot 104 formed between the upper cooling block 110a and the lower cooling block 102a. More specifically, in step 201 the elongated strip of steel 107a is fed within the elongated slot 104 formed between the upper quench plate 112 of the upper cooling block 110a, the lower quench plate 113 and the sidewalls 106a, 106b of the lower cooling block 102a. Additionally, in some embodiments in step 201 a second elongated strip of steel 107b is passed through an elongated slot 104 formed between the right upper cooling block 110b and the lower cooling block 102b.

In some embodiments, prior to step 201 the method 200 involves a step of calibrating the height or clearance 105 of the elongated gap 104, as discussed in the calibration method 250 of FIG. 13C.

In step 202, one or more characteristics of the elongated strip of steel emerging from the elongated slot are observed. In one embodiment, in step 202 a sweep of the elongated strip of steel 107a is observed as it emerges from the elongated slot 104 at the rear end 122 of the system 100. In some embodiments, step 202 is performed by an operator manually observing the sweep of the elongated strip of steel 107a and determining whether it is zero sweep 160 (FIG. 9C), positive sweep 162 (FIG. 11B) or negative sweep 164 (FIG. 10B). In other embodiments, a sensor such as an imaging device (e.g. camera) measures the sweep of the elongated strip of steel 107a emerging from the rear end 122 of the system 100. In an example embodiment, where the sensor is a camera, image data of the emerging strip of steel 107a is captured by the camera and transmitted to a processor which analyzes the image data to determine whether zero sweep 160, positive sweep 162 or negative sweep 164 is present in the elongated strip of steel 107a.

In other embodiments, in step 202 a distortion of the elongated strip of steel 107a emerging from the rear end 122 of the system 100 is observed. Distortion is present when the elongated strip of steel 107a deviates in a plane that is perpendicular to the plane 158 (FIG. 9B) defined by the elongated strip of steel 107a. In some embodiments, the distortion is observed in step 202 based on an operator manually observing reflections of light off the elongated strip of steel 107a that indicate a regular pattern of peaks and troughs along the elongated strip of steel 107a. In other embodiments, a sensor is provided to capture sensor data (e.g. camera that captures image data) of the elongated strip of steel 107a which is subsequently transmitted to a processor to assess whether distortion is present in the elongated strip of steel 107a.

In still other embodiments, in step 202 indicators of abrasion (e.g. scratching, rub marks, etc. on the elongated strip of steel 107a) between the quench plates 112, 113 and the elongated strip of steel 107a emerging from the rear end 122 of the system 100 are observed.

In step 204, a determination is made whether the observed characteristics in step 202 are desired. In some embodiments, where the observed characteristic is sweep, the determination in step 204 involves determining whether the observed sweep is zero sweep 160 (FIG. 9C). If zero sweep 160 is observed, then the determination in step 204 is in the affirmative and the method 200 proceeds back to step 201. In these embodiments, where the observed characteristic is sweep and either positive sweep 162 (FIG. 11B) or negative sweep 160 (FIG. 10B) are observed, the determination in step 204 is in the negative and the method 200 proceeds to step 206. In some embodiments, where the characteristic of the elongated strip of steel 107a is measured by a sensor in step 202, step 204 involves a processor that receives the sensor data determining whether the observed characteristic is desired. In this example embodiment, step 204 involves the processor processing the sensor data (e.g. image data) to determine the observed characteristic (e.g. whether the sweep is zero sweep 160, positive sweep 162 or negative sweep 164) and then comparing the observed characteristic with a desired characteristic (e.g. zero sweep 160) stored in a memory of the processor. If the observed characteristic matches the stored desired characteristic, the processor makes an affirmative determination in step 204 and the method 200 proceeds back to step 201 otherwise the method 200 continues to step 206.

In step 206, the position of the upper cooling block 110a is adjusted relative to the lower cooling block 102a to offset the undesired characteristic of the elongated strip of steel 107a observed in step 202. In some embodiments, step 206 involves moving the upper quench plate 112 of the upper cooling block 110a relative to the lower quench plate 113 of the lower cooling block 102a. In one embodiment, step 206 involves rotating one or more of the micrometers 118a, 118b, 118c in a particular direction by a particular extent. In an example embodiment, the operator can view a look up table or set of instructions which indicate which of the one or more micrometers 118a, 118b, 118c are to be rotated; which rotation direction each micrometer should be rotated; and by what extent to rotate each micrometer, depending on the undesired characteristic of the elongated strip of steel 107 observed in step 202. This set of instructions or look up table is prepared based on predetermining the adjustment parameters of the micrometers 118 (e.g. identification of which micrometers to adjust, the direction of rotation and the extent of such rotation) for each undesired strip characteristic, prior to the method 200 herein. In another example embodiment, these set of instructions or look up table is stored in a memory of a processor, such as the processor that processed the sensor data to determine the undesired characteristic in step 204. In this example embodiment, in step 206 the processor automatically transmits one or more signals to a motor or other component to automatically adjust the identified one or more micrometers 118 by the appropriate extent in the appropriate rotation direction, so to automatically offset the undesired characteristic in the elongated strip of steel 107.

In some embodiments, in step 206 a parallel adjustment of the upper quench plate 112 relative to the lower quench plate 113 along the width of the elongated slot 104 is performed. In one example, such a parallel adjustment involves moving the upper quench plate 112 closer to the lower quench plate 113, such as from the first position of FIG. 9A to the second position of FIG. 9B. In another example, such a parallel adjustment involves moving the upper quench plate 112 further away from the lower quench plate 113, such as from a first position of FIG. 9B to a second position of FIG. 9A. In these embodiments, the parallel adjustment is performed by rotating each of the micrometers 118a, 118b, 118c by a same extent in either the clockwise direction (moving the quench plate 112 away from the quench plate 113) or a counterclockwise direction (moving the quench plate 112 towards the quench plate 113). Additionally, in these embodiments a parallel adjustment of the upper quench plate 112 is performed in order to offset undesired characteristics of the elongated strip of steel 107a such as indicators of abrasion (e.g. scratching, rub marks, etc. on the elongated strip of steel 107a) between the quench plates 112, 113 and the elongated strip of steel 107a. In an example embodiment, in step 206 this undesired characteristic of the elongated strip of steel 107a may be alleviated by performing an adjustment (e.g. parallel adjustment) of the upper quench plate 112 so to increase the clearance between the upper quench plate 112 and the elongated strip of steel 107a. In other embodiments, where the abrasion is due to the elongated strip of steel 107a and the elongated slot 104 not oriented parallel to each other, the adjustment in step 206 of the upper cooling blocks 110, 111 involves tilting of the upper cooling blocks 110, 111 (e.g. using the micrometers 118a, 118b, 118c) until the level indicators 153, 155 confirm that the upper cooling blocks 110, 111 and thus the elongated slot 104 is level. Since the elongated strip of steel 107 incident on the system 100 is also measured as level, this adjustment should orient the elongated strip 104 to be parallel with the incident elongated strip of steel 107.

In other embodiments, in step 206 a non-parallel adjustment of the upper quench plate 112 relative to the lower quench plate 113 along the width of the elongated slot 104 is performed. Specifics of such a non-parallel adjustment using the micrometers 118a, 118b, 118c are discussed in more detail in the method 200′ of FIG. 13B. In one embodiment, such a non-parallel adjustment of the upper quench plate 112 relative to the quench plate 113 involves adjusting the position of the upper quench plate 112 so that it is closer to the sharpened edge 108 on the outboard side 132 of the elongated strip 107 than the control edge 109 on the inboard side 134 of the elongated strip 107 (FIG. 10A). This specific adjustment of the upper quench plate 112 is performed in order to address the positive sweep 162 (FIG. 11B) observed in the elongated strip 107a in step 202 by inducing the negative sweep 164 (FIG. 10B) in the elongated strip 107a and thus offsetting the observed positive sweep 162. In another embodiment, such a non-parallel adjustment of the upper quench plate 112 relative to the quench plate 113 involves adjusting the position of the upper quench plate 112 so that it is closer to the control edge 109 on the inboard side 134 of the elongated strip 107 than the sharpened edge 108 on the outboard side 132 of the elongated strip 107 (FIG. 11A). This specific adjustment of the upper quench plate 112 is performed in order to address the negative sweep 164 (FIG. 10B) observed in the elongated strip 107a in step 202 by inducing the positive sweep 162 (FIG. 11B) in the elongated strip 107a and thus offsetting the observed negative sweep 164.

In other embodiments, in step 206 the position of the rear upper cooling block 111a is adjusted relative to the lower cooling block 102a. In one embodiment, in step 206 the position of the upper quench plate 112 of the rear upper cooling block 111ais adjusted relative to the lower quench plate 113, such as in the parallel adjustment or non-parallel adjustment that was previously discussed with respect to the front upper cooling block 110a. In an example embodiment, the adjustment of the position of the rear upper cooling block 111a relative to the lower cooling block 102a is performed in order to offset any undesired characteristics of the elongated strip of steel 107a that is not offset by the adjustment of the front upper cooling block 110a. In one example embodiment, the collective adjustment of the both the front and rear upper cooling blocks 110a, 111a relative to the lower cooling block 102a are performed in order to collectively offset the undesired characteristics observed in step 204 in the elongated strip of steel 107a emerging at the rear end 122 of the system 100. In one embodiment, where multiple different undesired characteristics of the elongated strip 107 is observed in step 204, both the rear and front upper cooling blocks 110, 111 can be adjusted in step 206 to offset these multiple different undesired characteristics. In one example embodiment, where desired sweep or distortion combined with undesired indicators of abrasion between the quench plate 112 or 113 and the elongated strip 107 are observed in step 204, in step 206 both of the front and rear cooling blocks 110, 111 can be adjusted in step 206 to offset both of these undesired characteristics. In one example embodiment, the undesired sweep or distortion is offset by adjustment of the front upper cooling block 110 whereas the undesired indicators of abrasion are offset by adjustment of the rear upper cooling block 111. Since the temperature of the elongated strip of steel 107a is much less as it passes through the gap 104 formed between the rear upper cooling block 111a and the lower cooling block 102a, the scale to which adjustment of the rear upper cooling block 111a can offset an undesired characteristic in the elongated strip 107 is less than the adjustment of the front upper cooling block 110a. Consequently, in an example embodiment, adjustment of the rear upper cooling block 111a is performed in order to address smaller scale undesired characteristics in the elongated strip 107 than were addressed by adjustment of the front upper cooling block 110a.

In step 208, after performing the adjusting step 206 the characteristics of the elongated strip of steel 107a emerging at the rear end 122 of the system 100 are observed again. Step 208 then involves repeating step 204 so that another determination is made as to whether the adjusting step 206 removed the undesired characteristic (e.g. negative sweep 164, positive sweep 162, etc.) of the elongated strip of steel 107a emerging from the system 100. If the result of the determination in step 208 is in the affirmative, then the method 200 proceeds to step 210. Otherwise, the method 200 proceeds back to step 206. In this subsequent repeat of step 206, the adjusting step is repeated in order to address any undesired characteristics of the elongated strip of steel 107a observed in step 208 that were not addressed in the first iteration of step 206.

In step 210, a determination is made whether the end of the elongated strip 107a has emerged from the rear end 122 of the system 100. If so, then the method 200 ends. Otherwise, the method 200 proceeds back to step 201.

Another flowchart depicting one or more steps of a method 200′ for cooling a strip of steel 107a is now discussed. The method 200′ involves similar steps as the method 200 with the exception of the steps discussed herein. In step 202′, the method 200′ involves observing a sweep of the elongated strip of steel 107a emerging at the rear end 122 of the system 100. In step 204′ the method 200′ involves determining whether the observed sweep in step 202′ corresponds to a desired sweep (e.g. zero sweep 160 in FIG. 9C). If this determination is in the affirmative, the method 200′ proceeds back to step 201 and otherwise proceeds to step 205.

In step 205, a determination is made of one or more adjustment parameters of the upper cooling block 110a relative to the lower cooling block 102a. In one embodiment, the adjustment parameters of step 205 include an identification of one or more of the micrometers 118a, 118b, 118c to be adjusted; a rotation direction of each respective micrometer 118a, 118b, 118c to be adjusted; and a rotation extent of each respective micrometer 118a, 118b, 118c. In some embodiments, the adjustment parameters of the micrometers 118a, 118b, 118c are provided in a set of instructions or look up table so that the operator can determine the adjustment parameters for each undesired characteristic of the elongated strip of steel 107 observed in step 202′. Thus, the set of instructions or look up table identifies a respective set of adjustment parameters for the micrometers 118a, 118b, 118c for each undesired characteristic of the elongated strip of steel 107. In an example embodiment, in step 205 an operator inputs the observed undesired characteristics of steel 107 into a user interface of a computer. A processor of the computer has a memory that has the set of instructions stored for each observed undesired characteristic. The processor receives the inputted undesired characteristic of the strip 107 from the user interface and searches the stored set of instructions to locate the particular set of instructions (e.g. which micrometer to rotate, the rotation direction of each micrometer and a rotational extent of each micrometer). The processor then outputs this particular set of instructions on a display of the computer that is viewed by the operator. The operator can then manually rotate the micrometers in accordance with this specific set of instructions in the next method step 206.

In one example embodiment, in step 205 where positive sweep 162 is the observed undesired characteristic of the elongated strip 107 observed in step 204, in step 205 the set of instructions or look up table identify those micrometers 118 to be rotated, a rotation direction of each micrometer 118 and the rotational extent of each micrometer. Thus, in this example embodiment, the set of instructions or look up table identifies each of the micrometers 118a, 118b, 118c to be rotated; that the micrometers 118a, 118c should be rotated in a clockwise direction and the micrometer 118b should be rotated in a counter clockwise direction and that each micrometer 118 should be rotated between about 2-4 of the minor divisions 147 (FIG. 6A). This causes non-parallel adjustment of the upper quench plate 112 relative to the quench plate 113 so that the upper quench plate 112 is closer to the sharpened edge 108 on the outboard side 132 of the elongated strip 107 than the control edge 109 on the inboard side 134 of the elongated strip 107 (FIG. 10A). In some embodiments, the set of instructions or look up table may only indicate to rotate either the micrometers 118a, 118c in the clockwise direction by the 2-4 minor divisions 147 or the micrometer 118b in the counterclockwise direction by the 2-4 minor divisions 147. As previously disclosed herein, this non-parallel adjustment of the upper quench plate 112 is arranged to induce the negative sweep 164 (FIG. 10B) in the elongated strip 107 and thus offset the undesired positive sweep 162 observed in step 202′.

In one example embodiment, in step 205 where negative sweep 164 is the observed undesired characteristic of the elongated strip 107 observed in step 204, in step 205 the set of instructions or look up table identify those micrometers 118 to be rotated, a rotation direction of each micrometer 118 and the rotational extent of each micrometer. Thus, in this example embodiment, the set of instructions or look up table identifies each of the micrometers 118a, 118b, 118c to be rotated; that the micrometers 118a, 118c should be rotated in a counterclockwise direction and the micrometer 118b should be rotated in a clockwise direction and that each micrometer 118 should be rotated between about 2-4 of the minor divisions 147 (FIG. 6A). This causes non-parallel adjustment of the upper quench plate 112 relative to the quench plate 113 so that the upper quench plate 112 is closer to the control edge 109 on the inboard side 134 of the elongated strip 107 than the sharpened edge 108 on the outboard side 132 of the elongated strip 107 (FIG. 11A). In some embodiments, the set of instructions or look up table may only indicate to rotate either the micrometers 118a, 118c in the counterclockwise direction by the 2-4 minor divisions 147 or the micrometer 118b in the clockwise direction by the 2-4 minor divisions 147. As previously disclosed herein, this non-parallel adjustment of the upper quench plate 112 is arranged to induce the positive sweet 162 (FIG. 11B) in the elongated strip 107 and thus offset the undesired negative sweep 164 observed in step 202′.

In step 206′, after determining the adjustment parameters of the upper cooling block 110a relative to the lower cooling block 102a in step 205, in step 206′ the upper cooling block 110a is adjusted relative to the lower cooling block 102a in accordance with these adjustment parameters. In an example embodiment, in step 206′ the operator manually rotates the micrometers 118 based on the adjustment parameters determined in step 205 including rotating the identified one or more micrometers 118a, 118b, 118c, in the identified rotation direction for each micrometer and by the identified rotation extent provided in the determined adjustment parameters from step 205. In still other embodiments, in step 206′ a processor transmits a signal to a motor or other component to automatically rotate the identified micrometer(s) in the appropriate direction by the appropriate amount, as indicated in the set of instructions from step 205.

Steps 208′ and 210 of the method 200′ are similar to steps 208 and 210 of the method 200.

### Method for Calibration of System

A calibration method is now discussed, which is used to set the height or clearance 105 of the elongated slot 104 at a desired initial value prior to performing the method 200, 200′. FIG. 13C is a flowchart that depicts an example of one or more steps of a method 250 for initially calibrating the adjustable pins of the system 100 of FIG. 3A, according to various embodiments. As with the other methods 200, 200′, the method 250 herein is discussed when performed on the upper cooling block 110a mounted on the lower cooling block 102a. However, the same method 250 can be performed on the rear upper cooling block 111a mounted on the lower cooling block 102a, the front upper cooling block 110b mounted on the lower cooling block 102b or the rear upper cooling block 111b mounted on the lower cooling block 102b. For each of these upper cooling block and lower cooling block pairs, the method 250 is performed so to set a desired initial value of the height or clearance 105 of the elongated slot 104 between the upper and lower cooling blocks. As discussed in more detail herein, the value of the desired initial value of the height or clearance 105 of the elongated slot 104 differs between the front upper cooling blocks and lower cooling block as compared with between the rear upper cooling block and the lower cooling block.

In step 251, as shown in FIG. 12A an electronic height indicator 183 is provided that includes a probe 184 configured to measure a height 187 of the upper cooling block 110a mounted to the lower cooling block 102a. The electronic height indicator 183 also includes a display 185 to output various information (e.g. a value of the measured height 187). The electronic height indicator 183 also includes a user interface 186 through which can input various information (e.g. setting a numerical value of a measured height 187, such as setting the value to zero at a desired position). In an example embodiment, the electronic height indicator 183 also features a drive or motor to move the probe 184 up and down (based on input through the user interface 186). Although FIG. 12A depicts the electronic height indicator 183, the method 250 is not limited to using the electronic height indicator 183. In other embodiment, any device capable of measuring the height 187 of the upper cooling block 110a mounted to the lower cooling block 102a can be provided in step 251. In still other embodiments, no electronic height indicator or such device is provided in step 251 and instead the height measurement of the method 250 is manually performed by an operator with a measuring device (e.g. measuring tape, etc.). In this example embodiment, step 251 of the method 250 is omitted.

In step 253, the adjustable pins of the upper cooling block 110a are each retracted into the upper cooling block 110a so that the upper cooling block 110a makes contact with the lower cooling block 102a and is not parallel to the lower cooling block 102a along a width thereof. FIG. 12B depicts an example embodiment of the upper cooling block 110a and lower cooling block 102a after performing step 253. Each of the adjustable pins of the micrometers 118a, 118b, 118c are fully retracted into the upper cooling block 110a and thus none of the tips 148 of the adjustable pins make contact with the lower cooling block 102a. In one embodiment, step 253 involves fully rotating each of the micrometers 118a, 118b, 118c in the counterclockwise direction which causes retraction of the adjustable pin tips 148 into the upper cooling block 110a. As shown in FIG. 12B, the upper cooling block 110a is not parallel to the lower cooling block 102a along a width thereof, since the outboard side 132 of the upper cooling block 110a contacts the lower cooling block 102a whereas the inboard side 134 of the upper cooling block 110a does not contact the lower cooling block 102a. This is due to the upper quench plate 112 not completely received within the elongated slot 104, due to the orientation of the upper cooling block 110a.

In step 255, one of the adjustable pins of the upper cooling block 110a is extended out of the upper cooling block 110a into contact with the lower cooling block 102a until the upper cooling block 110a is parallel with the lower cooling block 102a along the width thereof. In one embodiment, FIG. 12C depicts the upper cooling block 110a and the lower cooling block 102a after step 255 is performed. The micrometer 118b on the outboard side 132 of the upper cooling block 110a has been rotated in the clockwise direction so that the adjustable pin tip 148b of the micrometer 118b presses on the lower cooling block 102a and thus raises the outboard side 132 of the upper cooling block 110a relative to the lower cooling block 102a. This rotation of the micrometer 118b is continued until the electronic height indicator 183 measures a same height 187 of the upper cooling block 110a at multiple measurement points 192a, 192b, 192c (FIG. 12D). FIG. 12C depicts the probe 184 of the electronic height indicator 183 positioned at two of the measurement points 192a, 192b. In some embodiments, the measurements points 192b, 192c are close as possible to an edge of the upper cooling block 110a on the inboard side 134 thereof and the measurement point 192b is as close as possible to an edge of the upper cooling block 110a on the outboard side 132 thereof. After step 255, the operator uses the user interface 186 to set the displayed height value to zero (e.g. 0.0000″).

In step 257, the remaining adjustable pins of the upper cooling block 110a are extended out of the upper cooling block 110a until each of the remaining adjustable pins are in contact with the lower cooling block 102a. In one embodiment, FIG. 12E depicts the upper cooling block 110a and the lower cooling block 102a after performing step 257. The micrometers 118a, 118c on the inboard side 134 of the upper cooling block 110a have been rotated in the clockwise direction so that the adjustable pin tips 148a, 148c of the micrometers 118a, 118c press on the lower cooling block 102a. This rotation of the micrometers 118a, 118c in step 257 is continued until a change in the measured height of the upper cooling block 110a is detected from the same height 187 of FIG. 12C to the increased same height 187′ of FIG. 12E. In an example embodiment, the increased same height 187′ corresponds to the smallest increase in height 187 that is capable of being detected by the electronic height indicator 183. Thus, in one embodiment as the operator rotates the micrometers 118a, 118c in step 257 the operator simultaneously views the display 185 and ceases rotation once the displayed value of the height 187 increases by the smallest detectable increment. As with step 255, the electronic height indicator 183 is also used to ensure that the same increased height 187′ is measured at each of the measurement points 192a, 192b, 192c to ensure that the upper cooling block 110a is parallel to the lower cooling block 102a along the width thereof. In an example embodiment, the electronic height indicator 183 is first used to detect a change in height on the inboard side 134 of the upper cooling block 110a, since that is the side of the upper cooling block 110a that will first change due to initial contact between the pin tips 148a, 148c of the micrometers 118a, 118c with the lower cooling block 102a. Additionally, in step 257 after performing this adjustment so that each of the micrometer pins are in contact with the lower cooling block 102a, the scales or indicia 144 (not the setup) of each micrometer 118 is set to zero.

In step 259, each of the adjustable pins of the upper cooling block 110a is extended until the height or clearance 105 of the elongated slot 104 corresponds to a desired initial value for performing the method 200, 200′ disclosed herein. In an embodiment, FIG. 12G depicts the upper cooling block 110a and the lower cooling block 102a after performing step 259. The micrometers 118a, 118b, 118c are each rotated in the clockwise direction so that the tips 148a, 148b, 148c of the adjustable pins press on the lower cooling block 102a and raise the upper cooling block 110a. As shown in FIG. 12G this raising of the upper cooling block 110a relative to the lower cooling block 102a eventually causes the upper quench plate 112 to raise within the slot 104 until the desired height or clearance 194 of the elongated slot 104 is achieved. In some embodiments, the desired height or clearance 194 is about 0.0038″ for the front upper cooling block 110a and about 0.0032″ for the rear upper cooling block 111a. In an example embodiment, since the scales or indicia 144 of the micrometers 118 were set to zero after step 257, in step 259 the micrometers 118a, 118b, 118c are each adjusted until the indicated value on the micrometer scale corresponds to the desired height or clearance 194. After setting the desired height or clearance 194 of the elongated slot 104, in step 259 the scales (not the setup) of the micrometers 118 are again adjusted so to have an even number (e.g. an even number such as 4 or 5 of the major division 146 is aligned with the edge 181 whereas the minor division 147 corresponding to zero is aligned with the vertical line 182).

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of cooling a strip of steel, the method comprising:
feeding a first elongated strip of steel between a front upper cooling block and a lower cooling block; and
adjusting a position of the front upper cooling block relative to the lower cooling block.

2. The method of claim 1, wherein the adjusting comprises turning a first micrometer positioned on the front upper cooling block.

3. The method of claim 2, wherein the adjusting comprises turning a second micrometer positioned on the upper cooling block.

4. The method of claim 3, wherein the adjusting compromises turning a third micrometer positioned on the upper cooling block.

5. The method of claim 1, wherein the adjusting comprises changing an angle of the front upper cooling block relative to the lower cooling block.

6. The method of claim 1, wherein the adjusting comprises changing a distance between the front upper cooling block and to the lower cooling block.

7. The method of claim 1, further comprising spacing the first elongated strip of steel apart from the front upper cooling block prior to the adjusting.

8. The method of claim 1, wherein the feeding comprises feeding the first elongated strip of steel between a pair of side walls of the lower cooling block.

9. The method of claim 1, further comprising feeding the first elongated strip of steel between a rear upper cooling block and the lower cooling block.

10. The method of claim 9, further comprising adjusting a position of the rear upper cooling block relative to the rear cooling block.

11. A method of cooling a strip of steel, the method comprising:
feeding an elongated strip of steel within an elongated slot formed between an upper cooling block and a lower cooling block;
determining a characteristic of the elongated strip of metal emerging from the elongated slot; and
wherein upon determining an undesired characteristic of the elongated strip of metal, adjusting a position of the upper cooling block relative to the lower cooling block to offset the undesired characteristic.

12. The method of claim 11, wherein the characteristic is a sweep of the elongated strip of metal.

13. The method of claim 11, wherein the characteristic is a distortion of the elongated strip of metal.

14. The method of claim 11, further comprising:
providing a plurality of micrometers on the upper cooling block, wherein the plurality of micrometers are operatively connected to a respective plurality of adjustable pins such that rotation of one or more of the plurality of micrometers causes a respective one or more of the plurality of adjustable pins to selectively engage or disengage the lower cooling block to vary the position of the upper cooling block relative to the lower cooling block;
wherein upon determining an undesired characteristic of the elongated strip of metal;
determining a direction of rotation and an extent of rotation of one or more of the plurality of micrometers to adjust the position of the upper cooling block relative to the lower cooling block so to offset the undesired characteristic of the elongated strip of metal, and
rotating the one or more of the plurality of micrometers by the determined extent in the determined direction.

15. The method of claim 14, wherein the characteristic is a sweep of the elongated strip of metal.

16. The method of claim 15, wherein upon determining a negative sweep of the elongated strip of metal;
wherein the determining the direction of rotation and the extent of rotation step comprises determining a first direction of rotation and a first extent for one or more of the plurality of micrometers positioned on an outboard side of the elongated slot and determining a second direction of rotation and a second extent for one or more of the plurality of micrometers positioned on an inboard side of the elongated slot so that a quench plate of the upper cooling plate is closer to a control edge of the elongated strip of steel than a sharpened edge of the elongated strip of steel; and
wherein the rotating step comprises rotating, in the first direction of rotation, the one or more of the plurality of micrometers positioned on the outboard side by the first extent and rotating, in the second direction of rotation, the one or more of the plurality of micrometers positioned on the inboard side by the second extent.

17. The method of claim 15, wherein upon determining a positive sweep of the elongated strip of metal;
wherein the determining the direction of rotation and the extent of rotation step comprises determining a first direction of rotation and a first extent for one or more of the plurality of micrometers positioned on an inboard side of the elongated slot and determining a second direction of rotation and a second extent for one or more of the plurality of micrometers positioned on an outboard side of the elongated slot so that a quench plate of the upper cooling plate is closer to a sharpened edge of the elongated strip of steel than a control edge of the elongated strip of steel; and
wherein the rotating step comprises rotating, in the first direction of rotation, the one or more micrometers positioned on the inboard side by the first extent and rotating, in the second direction of rotation, the one or more micrometers positioned on the outboard side by the second extent.

18. A method of calibrating a system for cooling a strip of steel, the method comprising:
providing a height indicator with a probe configured to measure a height of an upper cooling block mounted on a lower cooling block with a plurality of adjustable pins;
retracting, into the upper cooling block, each of the adjustable pins such that the upper cooling block is in contact and not parallel to the lower cooling block along a width thereof;
extending, out of the upper cooling block, one of the adjustable pins into contact with the lower cooling block until the upper cooling block is parallel with the lower cooling block along the width thereof, wherein said extending step includes measuring, with the height indicator, a same first height of the upper cooling block along a width thereof; and
extending, out of the upper cooling block, the remaining adjustable pins into contact with the lower cooling block until an increase in the height is detected with the height indicator from the same first height to a same second height, wherein said extending step includes measuring, with the height indicator, the same second height of the upper cooling block along a width thereof;
extending, out of the upper cooling block, each adjustable pin into contact with the lower cooling block until an increase in the height is detected with the height indicator from the same second height to a same third height and such that a gap is provided between a quench plate of the upper cooling block and a quench plate of the lower cooling block with a desired value.

19. The method of claim 18, wherein a plurality of micrometers is provided on the upper cooling block that are operatively connected to the respective plurality of adjustable pins;
wherein the retracting step comprises rotating, in a first direction, each of the plurality of micrometers by a first extent such that each of the adjustable pins retract into the upper cooling block and do not make contact with the lower cooling block;
wherein the extending the one of the adjustable pins out of the cooling block comprises rotating, in a second direction, one of the micrometers that is operatively connected with the one of the adjustable pins by a second extent such that the one of the adjustable pins extends out of the upper cooling block and makes contact with the lower cooling block and wherein the second extent is based on the measuring, with the height indicator, the same first height of the upper cooling block along the width thereof;
wherein the extending the remaining adjustable pins out of the cooling block comprises rotating, in a second direction, the remaining micrometers operatively connected to the respective remaining adjustable pins by a second extent such that the remaining adjustable pins extends out of the upper cooling block and make contact with the lower cooling block and wherein the second extent is based on the measuring, with the height indicator, the same second height of the upper cooling block along the width thereof.
